(19) United States
(12) Patent Application Publication
(10) Pub. No.: US 2021/0114364 A1
(43) Pub. Date: Apr. 22, 2021

(54) BRITTLE MATERIAL STRUCTURE AND MANUFACTURING METHOD OF THE SAME

(71) Applicant: NATIONAL INSTITUTE OF ADVANCED INDUSTRIAL SCIENCE AND TECHNOLOGY, Tokyo (JP)

(72) Inventors: Muneyasu SUZUKI, Tsukuba-shi (JP); Jun AKEDO, Tsukuba-shi (JP); Tetsuo TSUCHIYA, Tsukuba-shi (JP)

(21) Appl. No.: 17/112,508

(22) Filed: Dec. 4, 2020

Related U.S. Application Data
(63) Continuation of application No. PCT/JP2019/021784, filed on May 31, 2019.

(30) Foreign Application Priority Data
Jun. 8, 2018 (JP) 2018-110527

(51) Int. Cl. B32B 37/00; B32B 38/10; B32B 38/00; B32B 5/30; B32B 18/00; C04B 35/491; B32B 7/022; B32B 7/12

(52) U.S. Cl. CPC B32B 37/025; B32B 38/10; B32B 38/0008; B32B 5/30; B32B 18/00; C04B 35/491; B32B 2307/51; B32B 7/12; B32B 2264/107; B32B 2264/1023; B32B 2307/536; C04B 2235/3217; C04B 2235/3249; B32B 7/022

(57) ABSTRACT

First brittle material particles; and second brittle material particles having smaller size than the first brittle material particles, wherein a void formed between the first brittle material particles is filled with at least one of the second brittle material particles, at a porosity of less than 20%.

### CROSS REFERENCE TO RELATED APPLICATIONS

This application is based upon and claims the benefit of priority from the prior Japanese Patent Application No. 2018-110527, filed on Jun. 8, 2018, and PCT Application No. PCT/JP2019/021784 filed on May 31, 2019, the entire contents of which are incorporated herein by reference.

### FIELD

The present application relates to a new structure of oxide ceramics and to a technique for manufacturing structure.

Oxide ceramics are widely applied as electronic ceramics utilizing such piezoelectric and dielectric properties. Recently, in order to apply it to the wearable device, there is a demand for the development of “the flexible device” in which a flexible organic substance such as plastic and electronic ceramics are combined.

“Oxide all-solid Lithium-ion secondary battery” attracts attention as a next-generation storage battery. In the “oxide all-solid-state lithium-ion secondary battery”, first, the active material of the oxide ceramics, the solid electrolyte, and the auxiliary agent for supplementing the conductivity and the like are uniformly deposited on the metal foil without any gaps. As a result, a positive electrode mixture and a negative electrode mixture are prepared respectively. Further, a very advanced technique of bonding the positive electrode mixture and the negative electrode mixture without gap by sandwiching the solid electrolyte of the oxide is required.

### BACKGROUND

The oxide ceramics generally need a very high baking temperature for high-density sintering. In the flexible device and oxide all-solid state lithium-ion secondary battery, inexpensive and flexible metal foils such as aluminum and copper, or plastic are used. However, these materials have very low heat resistance and cannot withstand the sintering temperature and oxidizing atmosphere of oxide ceramics.

Traditionally, the following methods have been employed to manufacture the structure of the oxide ceramics. For example, additive methods are used to lower the sintering temperature or add reduction resistance by adding additives. Sputtering method, PLD method, CVD method, MOD (sol-gel) method, hydrothermal synthesis, screen printing, EPD method, and cold sintering method are all applied to deposit oxide ceramics films at the lower temperature than the sintering temperature. The technique of shaping and stacking raw particles into nano-sized sheets or cubes is an example. The aerosol deposition (AD) method is used to solidify the raw particles by impacting them on the substrate at room temperature.

### SUMMARY

The present inventors have diligently studied a structure of oxide ceramics capable of solving some problems of the prior art, and a method for producing the same. As a result, they found a method for stacking brittle material structures on a substrate by repeating the process of depositing particles made of the brittle materials such as alumina and lead zirconate titanate (PZT) on a transfer plate and pressuring and transferring the particles onto the substrate. It was found that the method provides a structure of oxide ceramics that can solve some problems.

The specific method is described below. As a transfer plate, a metal plate having a high enough modulus of elasticity that no brittle material remains during pressuring and transferring is used. When particles comprising the brittle material are deposited on the transfer plate, first larger particles are deposited first. Thereafter, second particles, which are smaller in particle size than the first particles, are deposited on the first particles. A substrate including of a metal or carbon with a low modulus of elasticity sufficient to allow the brittle material to adhere to it during pressurized transfer is provided. A thin layer of brittle material (also referred to as the brittle material layer) adhered to the transfer plate is transferred onto the substrate by applying pressure at a pressure lower than that these particles are crushed. The first and second particles are then deposited on the transfer plate using the mentioned above process. The thin layer side of the brittle material of the substrate to which the thin layer of the brittle material is transferred is arranged on the surface side to which the second particles are attached, and the pressure is applied. The thin layer of the brittle material adhered to the transfer plate is transferred onto the thin layer on the substrate and stacked. By repeating these processes, a structure of the brittle material having the desired thickness is provided on the substrate.

Forming a thin layer of the brittle material on the transfer plate includes adhering the first particles with a large particle size, and adhering a mixture of the first particles and the second particles having a particle size smaller than that of the first particle thereon. Further, the second particles may be adhered thereon.

When the thin layer of the brittle material deposited on the transfer plate is pressure-transferred to the substrate, the substrate may be vibrated in the lateral direction.

The brittle material structure thus produced can be pressure-cohered at pressure lower than a pressure at which the particles are crushed without heat-treating the particles of the brittle material. By filling the voids existing between the first particles arranged densely with the second particles, an extremely high-density structure having a porosity of 20% or less can be provided.

Specifically, the present application provides the following invention.

<1> A brittle material structure including first brittle material particles, and second brittle material particles having smaller size than the first brittle material particles, wherein a void formed between the first brittle material particles is filled with at least one of the second brittle material particles, at a porosity of less than 20%.

<2> A ratio of an average size of the second brittle material particles to an average size of the first brittle material particles is 0.75 or less.

<3> A ratio of a volume occupied by the second brittle material particles to a volume occupied by the first brittle material particles and the second brittle material particles is 15% to 60%, and an average size of the first brittle material particles is 100 nm or more, and an average size of the second brittle material particles is 3 μm or less.

<4> The brittle material structure has Vickers hardness of HV250 or less.

<5> The brittle material structure has a stacked structure including brittle material layers composed of the first brittle material particles and the second brittle material particles, and the brittle material layers are stacked.

<6> A manufacturing method of the brittle material structure comprising the steps of:

(i) adhering first brittle material particles on a transfer plate, and adhering second brittle material particles on the first brittle material particles to form a brittle material layer on the transfer plate, the transfer plate being a metal plate with a high enough elasticity modulus to prevent the brittle material layer from remaining on the metal plate in step (ii);

(ii) providing the substrate on a surface of the transfer plate on which the second brittle material particles are adhered, and transferring the brittle material layer adhered to the transfer plate onto the substrate by pressurizing the first brittle material particles and the second brittle material particles at a pressure lower than a pressure at which the first brittle material particles and the second brittle material particles are crushed, the substrate being composed of a metal or carbon with a low enough modulus of elasticity to allow the brittle material layer to adhere to the substrate during pressure transfer; and

(iii) adhering the first brittle material particles and the second brittle material particles to the transfer plate using the same process as in the step (i), and transferring the brittle material layer adhered to the transfer plate onto the brittle material layer on the substrate by placing the brittle material layer of the transfer plate on the surface of the transfer plate on which the second brittle material particles are adhered, and applying pressure to the brittle material layer on the transfer plate,

wherein a structure having a desired thickness and formed by cohering the first brittle material particles and the second brittle material particles on the substrate is formed by repeating the step (iii).

<7> In the steps (ii) and (iii), applying vibration in a lateral direction of the transfer plate to transfer the brittle material layer adhered on the transfer plate to the substrate or the surface of the transfer plate on which the second brittle material particles under pressure.

<8> A manufacturing method of the brittle material structure comprising the steps of:

(iv) adhering the first brittle material particles on a transfer plate, and adhering a mixture of the first brittle material particles and the second brittle material particles onto the first brittle material particles on the transfer plate, and adhering the second brittle material particles onto the mixture, the transfer plate being a metal plate with a high enough elasticity modulus to prevent the brittle material layer from remaining on the metal plate in step (v);

(v) providing the substrate on a surface of the transfer plate on which the second brittle material particles are adhered, and transferring the brittle material layer adhered to the transfer plate onto the substrate by pressurizing the first brittle material particles and the second brittle material particles at a pressure lower than a pressure at which the first brittle material particles and the second brittle material particles are crushed, the substrate being composed of a metal or carbon with a low enough modulus of elasticity to allow the brittle material layer to adhere to the substrate during pressure transfer; and

(vi) adhering the first brittle material particles and the second brittle material particles to the transfer plate using the same process as in the step (iv), and transferring the brittle material layer adhered to the transfer plate onto the brittle material layer on substrate by placing the brittle material layer of the transfer plate on the surface of the transfer plate on which the second brittle material particles are adhered, and applying pressure to the brittle material layer on the transfer plate, wherein a structure having a desired thickness and formed by cohering the first brittle material particles and the second brittle material particles on the substrate is formed by repeating the step (vi).

<9> In the steps (v) and (vi), applying vibration in a lateral direction of the transfer plate to transfer the brittle material layer adhered on the transfer plate to the substrate under pressure.

According to the present invention, a structure in which the raw material fine particles are arranged in a highly dense manner is formed by pressurizing the powder of the raw material fine particles of a highly crystalline and the brittle material into a thin layer by pressurizing the powder at a pressure lower than that at which the particles are crushed. Furthermore, the structure in which the raw material fine particles are similarly highly densely arranged is stacked on top of the structure in a pressurized manner so as to unify it. As a result, a high-density brittle material structure with a relative density of 80% or more (porosity of 20% or less) can be obtained by agglomeration of the raw material fine particles.

Since the brittle material structure according to the present invention is formed by agglomeration of raw material fine particles, the high crystallinity of the original raw material fine particles can be maintained, and internal stress is less likely to occur.

According to the present invention, there is no need for sintering, crushing of raw material fine particles, processes under vacuum or decompression, or the use of binders, which were conventionally required to fabricate high-density oxide ceramics structures. Therefore, the generation of defect and inner stresses in the crystals that accompany these steps can be suppressed.

### BRIEF DESCRIPTION OF DRAWINGS

FIG. 1A is a schematic view showing a manufacturing procedure of a brittle material structure according to the present invention;

FIG. 1B is a schematic view showing a manufacturing procedure of a brittle material structure according to the present invention;

FIG. 10 is a schematic view showing a manufacturing procedure of a brittle material structure according to the present invention;

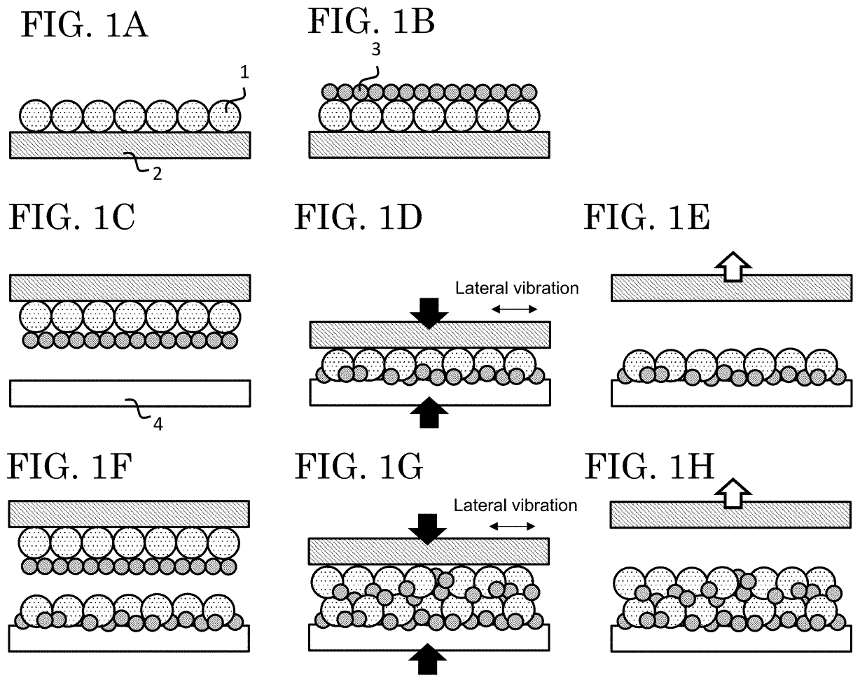

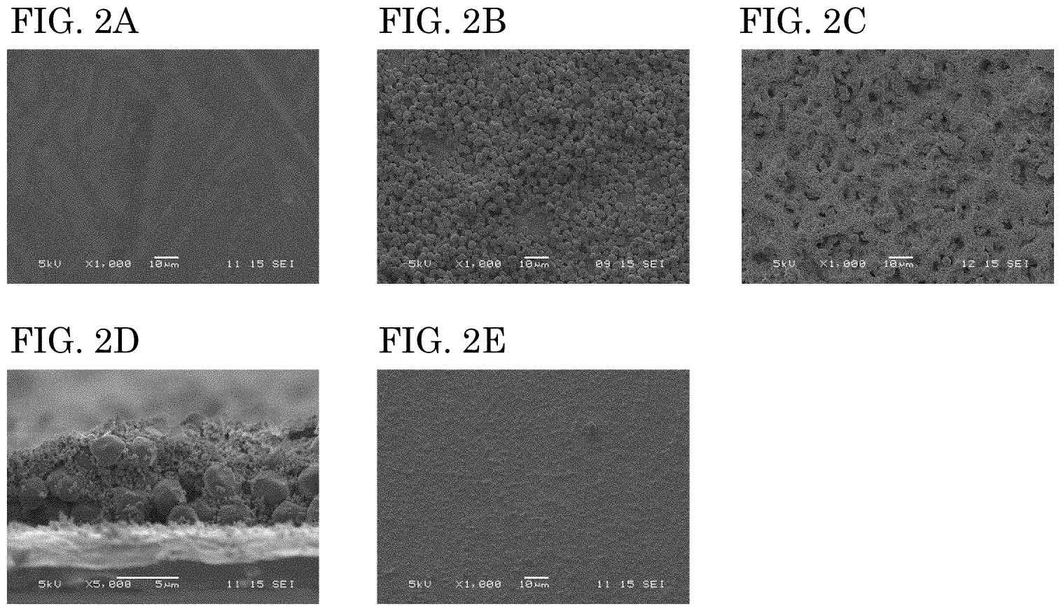

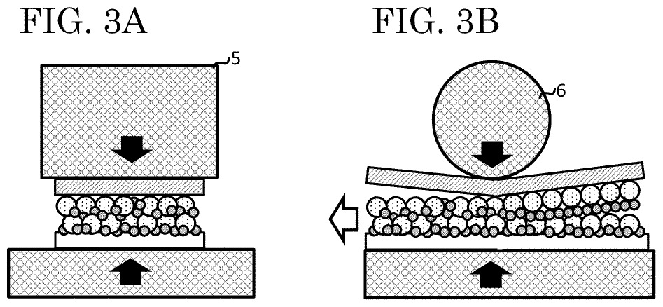

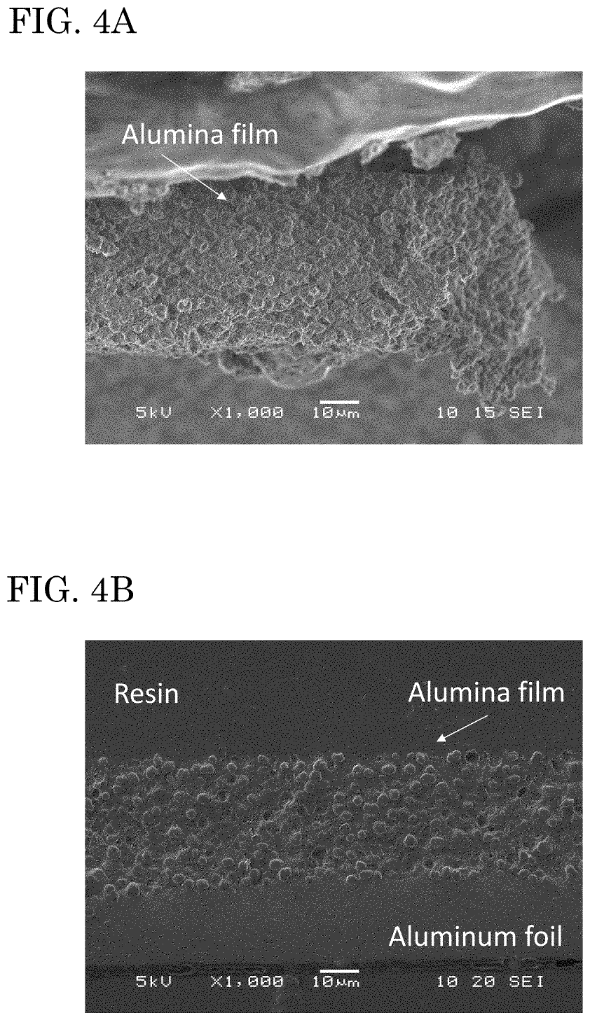

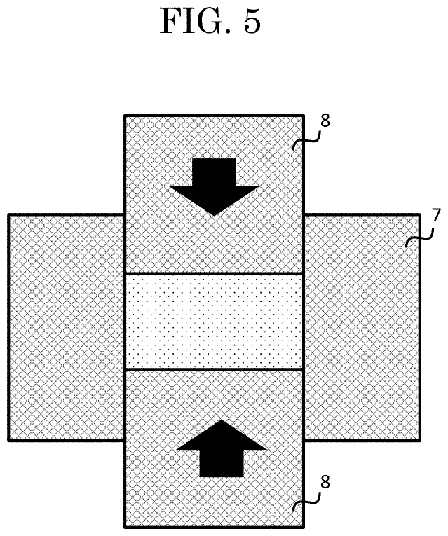

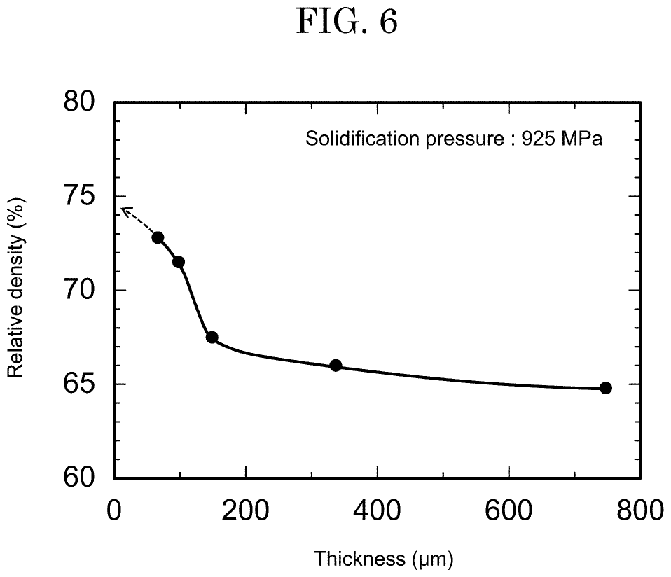

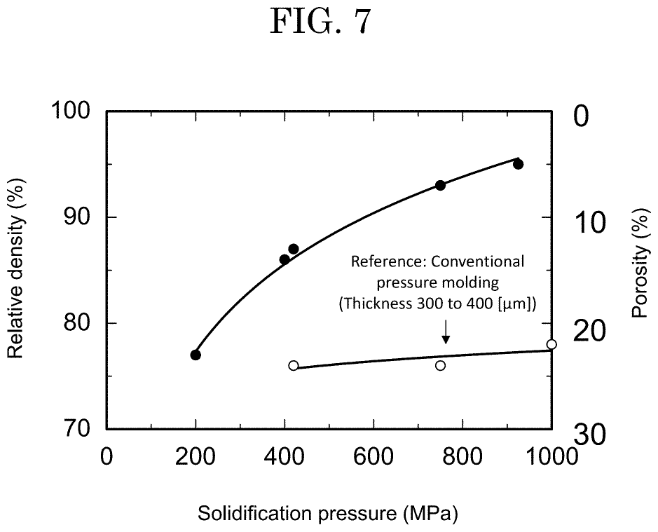

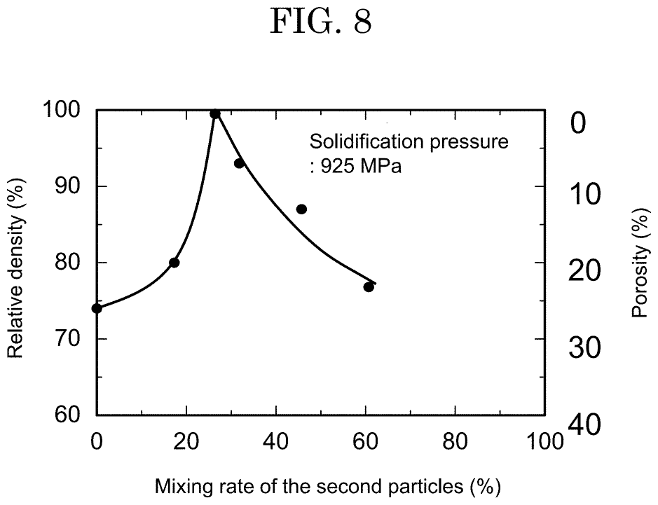

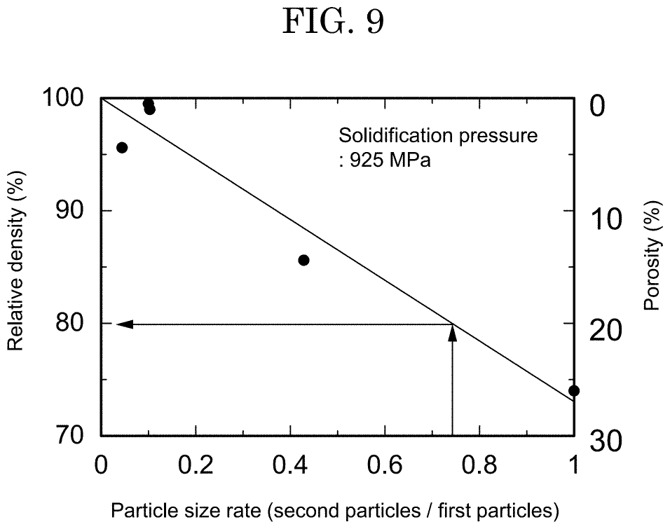

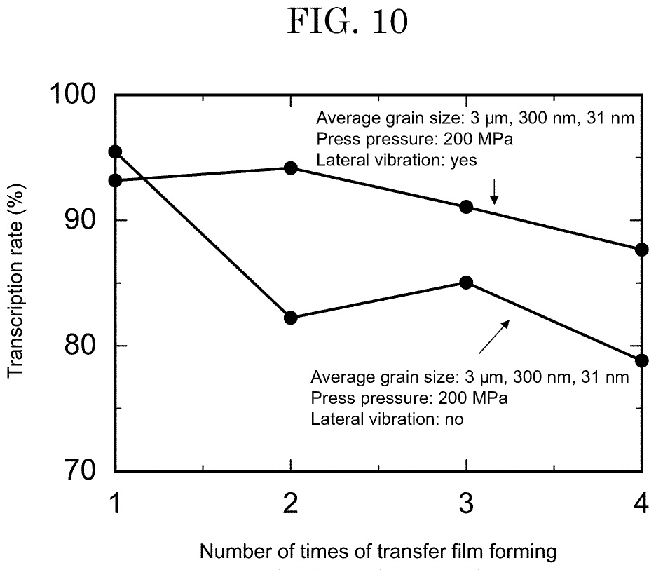

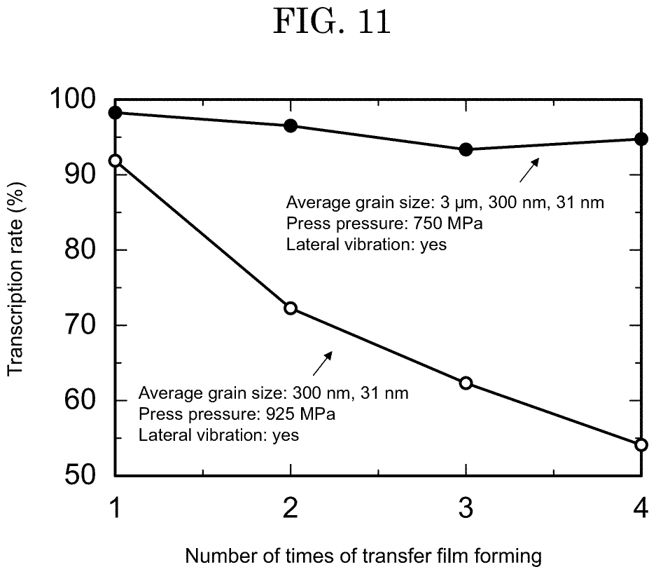

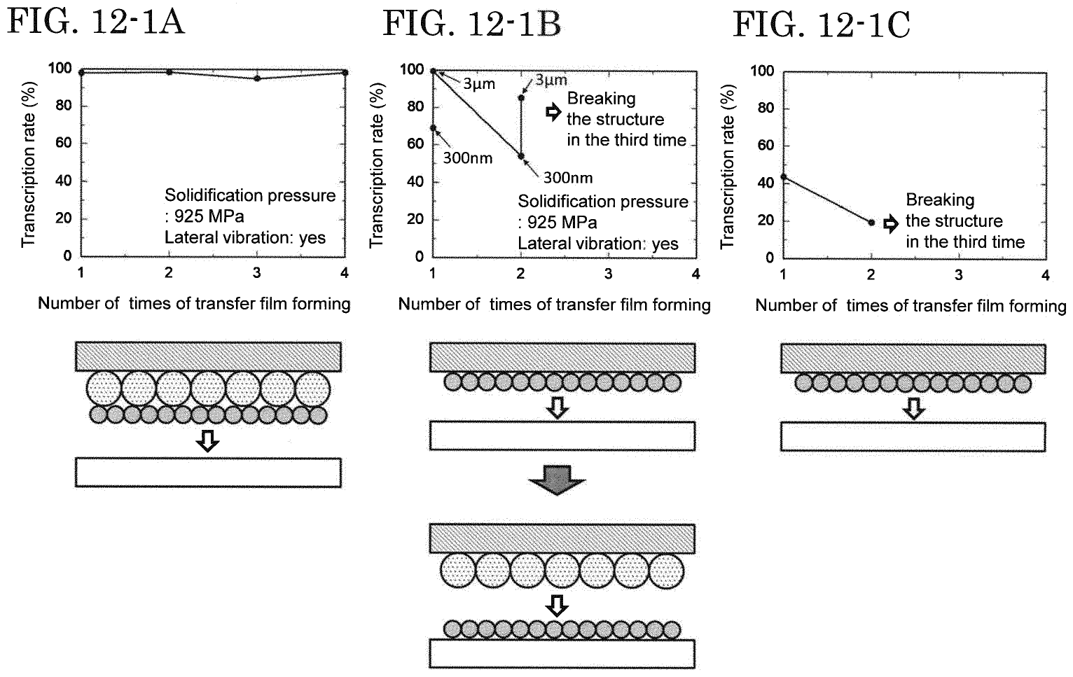

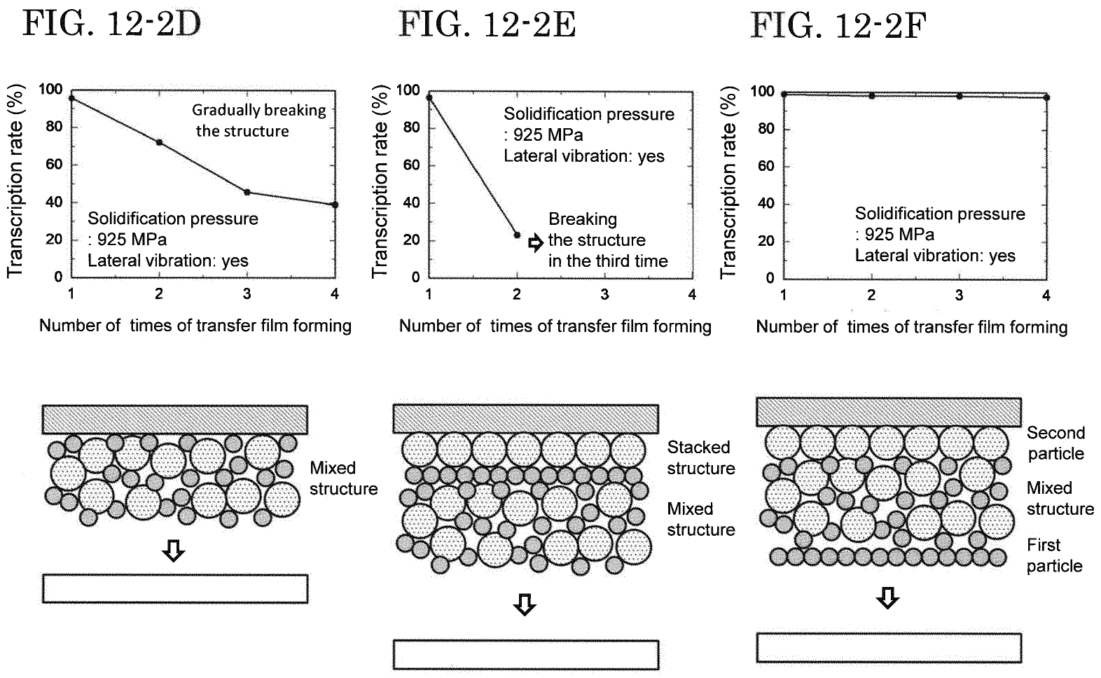

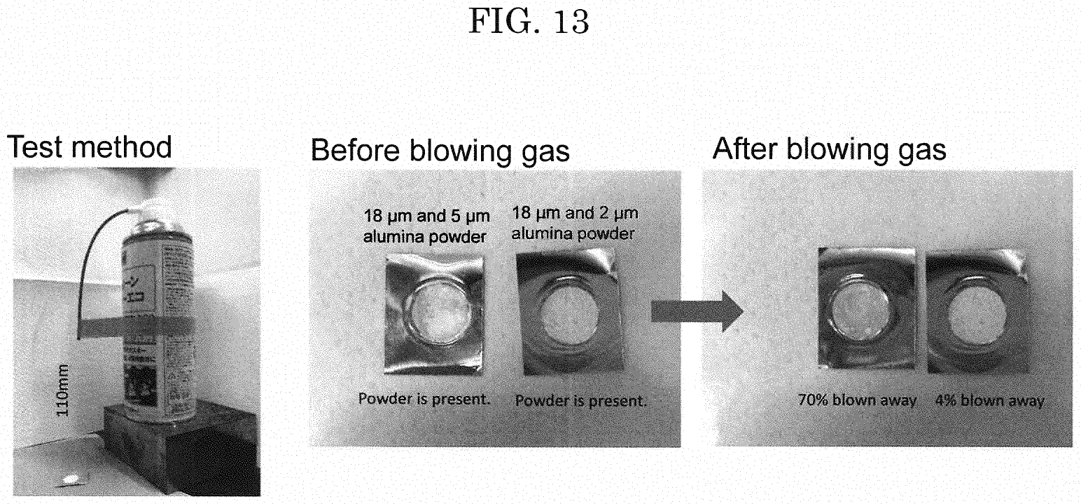

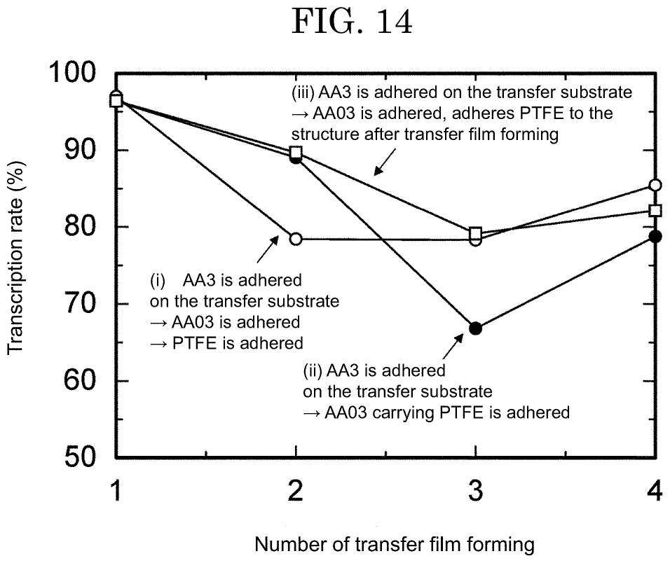

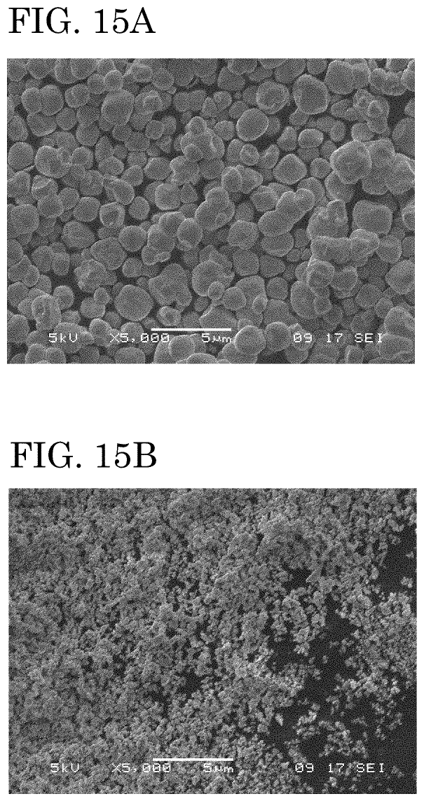

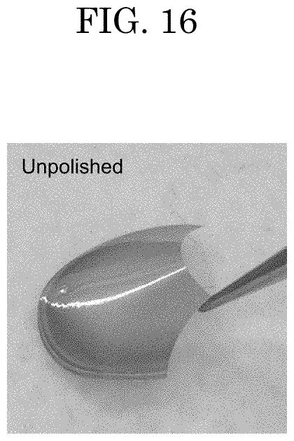

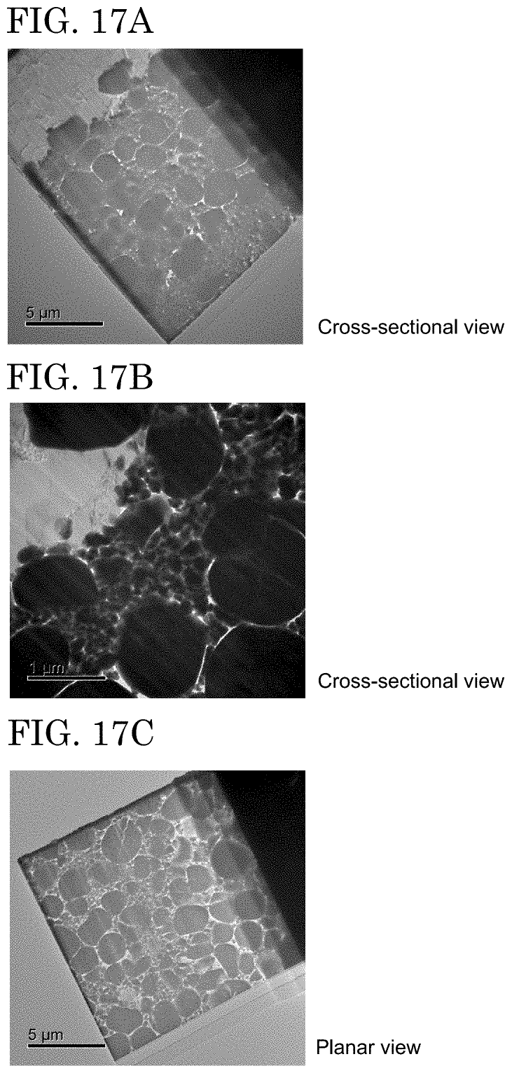

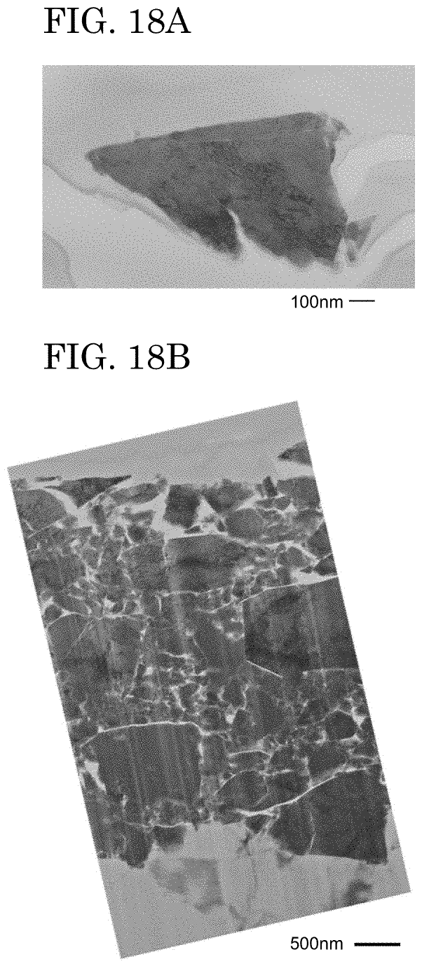

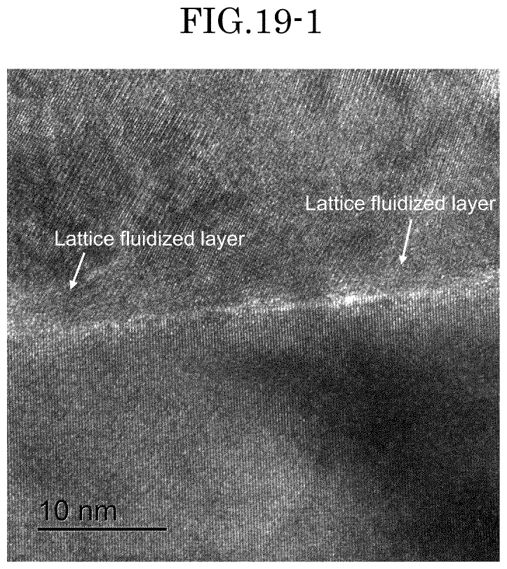

FIG. 1D is a schematic view showing a manufacturing procedure of a brittle material structure according to the present invention;

FIG. 1E is a schematic view showing a manufacturing procedure of a brittle material structure according to the present invention;

FIG. 1F is a schematic view showing a manufacturing procedure of a brittle material structure according to the present invention;

FIG. 1G is a schematic view showing a manufacturing procedure of a brittle material structure according to the present invention;

FIG. 1H is a schematic view showing a manufacturing procedure of a brittle material structure according to the present invention;

FIG. 2A is a surface SEM image of raw material fine particles on a transfer plate;

FIG. 2B is a surface SEM image of raw material fine particles on a transfer plate;

FIG. 20 is a surface SEM image of raw material fine particles on a transfer plate;

FIG. 2D is a cross-sectional SEM image of raw material fine particles on a transfer plate;

FIG. 2E is a surface SEM image of raw material fine particles on a transfer plate;

FIG. 3A is a schematic view of a transfer film forming apparatus;

FIG. 3B is a schematic view of a transfer film forming apparatus;

FIG. 4A shows a fractured surface of a self-supporting film which is peeled from an aluminum foil of a substrate after the transfer film formation on the aluminum foil at a solidification pressure of 420 MPa;

FIG. 4B is a cross-sectional SEM image of a sample transferred to an aluminum foil at a solidification pressure of 925 MPa, subjected to resin filling treatment, and cut and polished;

FIG. 5 is a schematic view of a manufacturing apparatus by a conventional pressure molding method using a mold;

FIG. 6 is a graph showing the relationship between the film thickness and the relative density when the alumina is pressure-molded at a solidification pressure 925 MPa;

FIG. 7 is a graph for comparing the relationship between the solidification pressure and the relative density (porosity) of the alumina brittle material structure according to the present invention and the prior art;

FIG. 8 is a graph showing the relationship between the mixing rate and the relative density (porosity) of the second particles of the alumina brittle material structure according to the present invention;

FIG. 9 is a graph showing the relationship between the particle size rate and the relative density (porosity) of the alumina brittle material structure according to the present invention;

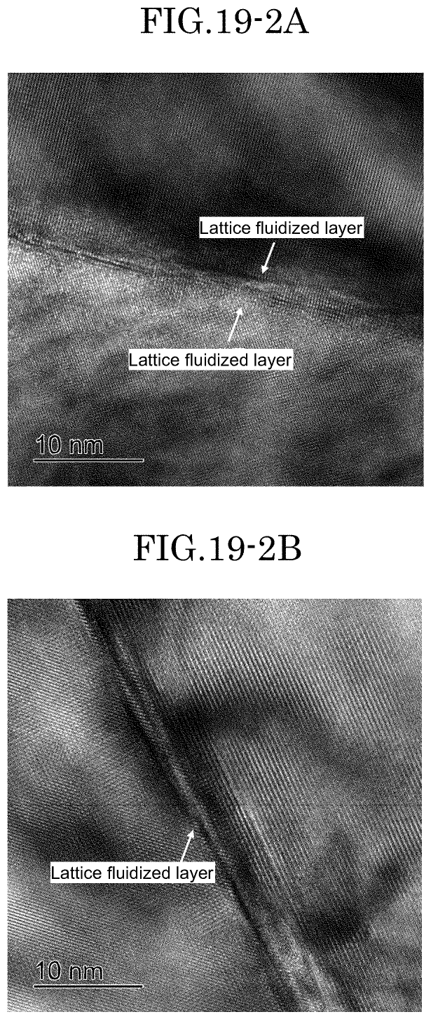

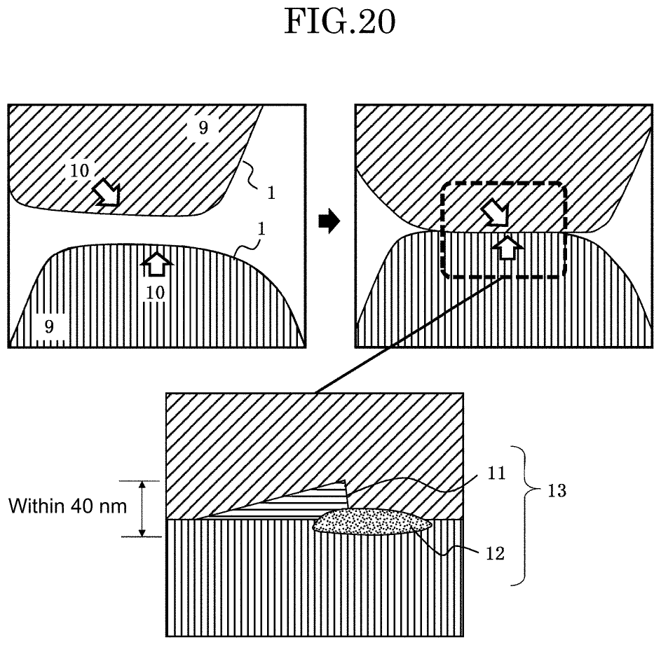

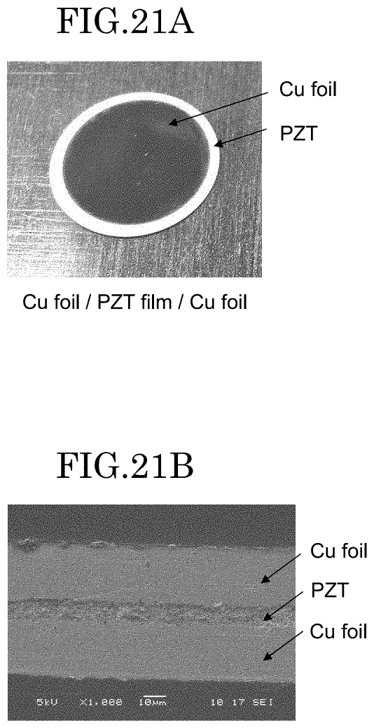

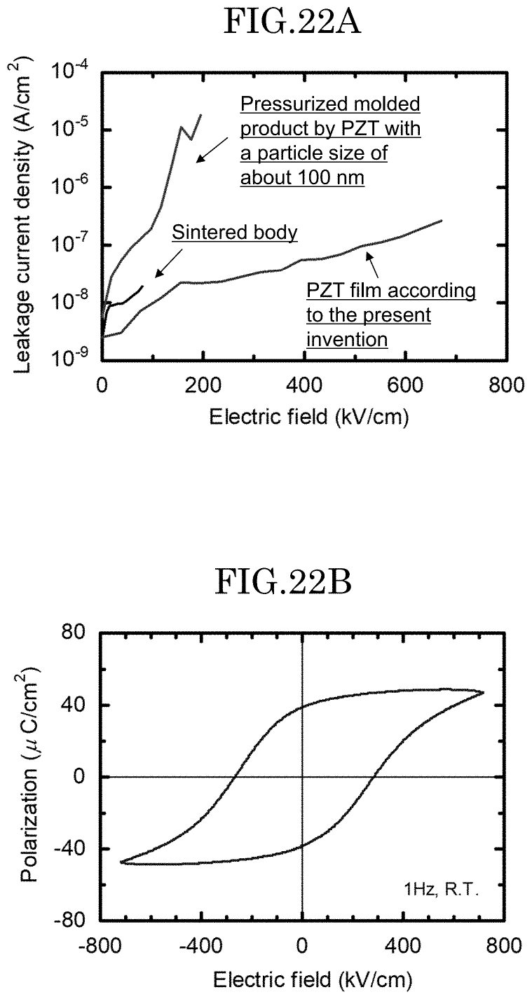

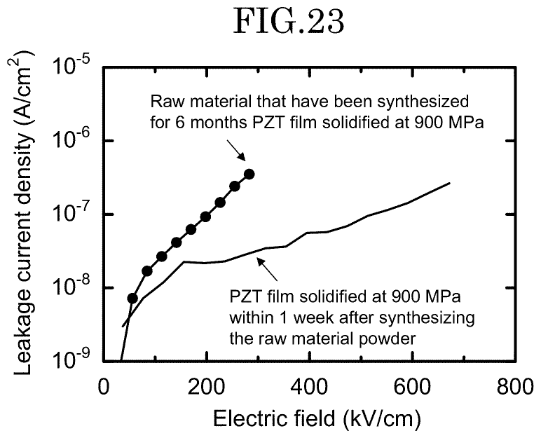

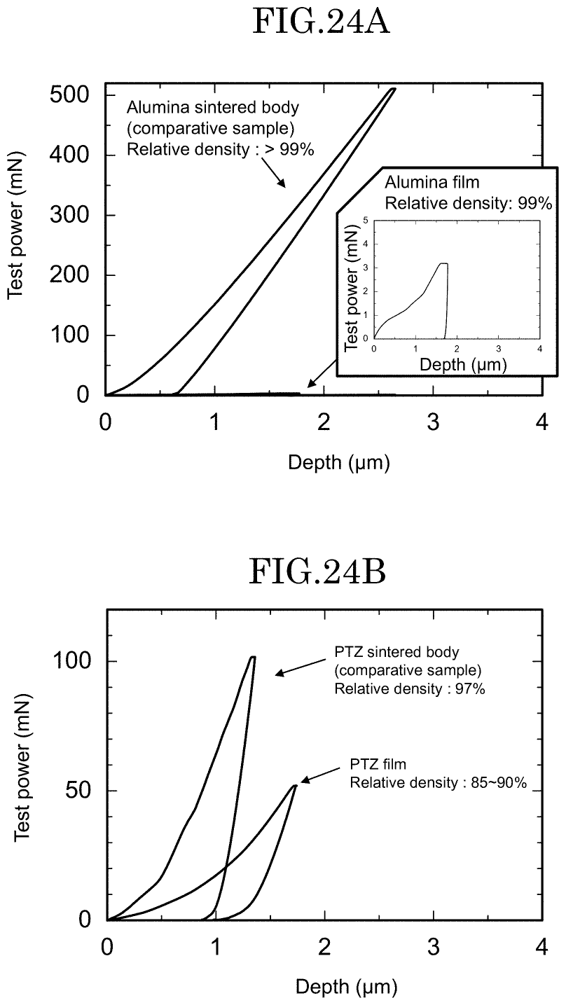

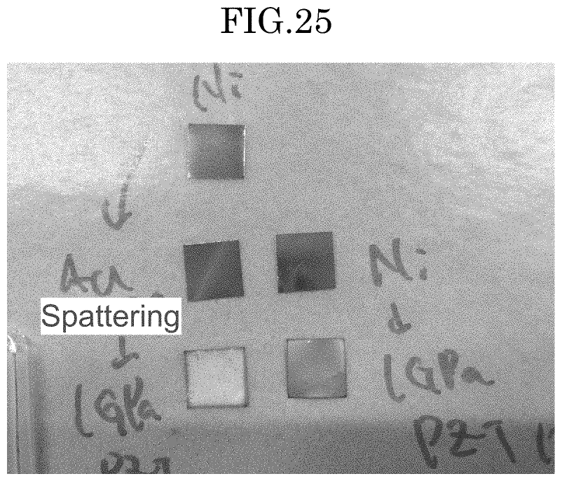

FIG. 10 is a graph for contrasting the relationship between the numbers and transcription rate of the transfer film formation with lateral vibration or without lateral vibration during the production of the alumina brittle material structure according to the present invention;

FIG. 11 is a graph showing the relationship between the transcription rate and the number of transference of the first particles contained in the alumina brittle material structure according to the present invention;

FIG. 12-1A is a graph showing the influence of the state of the production of the alumina brittle material structure according to the present invention on the relationship between the transcription rate and the number of times of the transfer film formation (part 1);

FIG. 12-1B is a graph showing the influence of the state of the production of the alumina brittle material structure according to the present invention on the relationship between the transcription rate and the number of times of the transfer film formation (part 1);

FIG. 12-1C is a graph showing the influence of the state of the production of the alumina brittle material structure according to the present invention on the relationship between the transcription rate and the number of times of the transfer film formation (part 1);

FIG. 12-2D is a graph showing the influence of the state of the production of the alumina brittle material structure according to the present invention on the relationship between the transcription rate and the number of times of the transfer film formation (part 2);

FIG. 12-2E is a graph showing the influence of the state of the production of the alumina brittle material structure according to the present invention on the relationship between the transcription rate and the number of times of the transfer film formation (part 2);

FIG. 12-2F is a graph showing the influence of the state of the production of the alumina brittle material structure according to the present invention on the relationship between the transcription rate and the number of times of the transfer film formation (part 2);

FIG. 13 is a comparative image of the influence of the size of the second particles contained in the alumina brittle material structure according to the present invention on the formation of the film;

FIG. 14 is a graph showing the influence on the relationship between the number of transfer film formations and the transcription rate in the state in which PTFE is mixed in the production of the alumina brittle material structure according to the present invention;

FIG. 15A is a SEM image of PZT raw material fine particles;

FIG. 15B is a SEM image of PZT raw material fine particles;

FIG. 16 is an image of a PZT brittle material structure according to the present invention on an aluminum foil;

FIG. 17A is a TEM image of a PZT brittle material structure (solidification pressure: 900 MPa) according to the present invention formed of spherical raw material fine particles;

FIG. 17B is a TEM image of a PZT brittle material structure (solidification pressure: 900 MPa) according to the present invention formed of spherical raw material fine particles;

FIG. 17C is a TEM image of a PZT brittle material structure (solidification pressure: 900 MPa) according to the present invention formed of spherical raw material fine particles;

FIG. 18A is a TEM image of a PZT brittle material structure (solidification pressure: 900 MPa) according to the present invention formed of angled raw material fine particles;

FIG. 18B is a TEM image of a PZT brittle material structure (solidification pressure: 900 MPa) according to the present invention formed of angled raw material fine particles;

FIG. 19-1 is a TEM image of an interface of a brittle material structure of PZT according to the present invention;

FIG. 19-2A is a TEM image of an interface of a brittle material structure of barium titanate according to the present invention and a brittle material structure of barium titanate heat-treated at 600° C.;

FIG. 19-2B is a TEM image of an interface of a brittle material structure of barium titanate according to the present invention and a brittle material structure of barium titanate heat-treated at 600° C.;

FIG. 20 is a schematic view of a lattice fluidized layer formed at a bonding interface when the raw material fine particles having a lattice alignment layer flow and come into contact with each other and cohere at a solidification pressure in the present invention;

FIG. 21A is an image and a cross-sectional SEM image of the PZT brittle material structure according to the present invention bonded to a copper foil;

FIG. 21B is an image and a cross-sectional SEM image of the PZT brittle material structure according to the present invention bonded to a copper foil;

FIG. 22A is a graph showing the electrical property of a PZT brittle material structure according to the present invention;

FIG. 22B is a graph showing the electrical property of a PZT brittle material structure according to the present invention;

FIG. 23 is a graph showing the leakage current characteristic of a PZT brittle material structure according to the present invention;

FIG. 24A is a graph comparing the mechanical property of brittle material structures according to the present invention and sintered bodies containing alumina and PZT;

FIG. 24B is a graph comparing the mechanical property of brittle material structures according to the present invention and sintered bodies containing alumina and PZT; and

FIG. 25 is an image comparing an example in which a PZT brittle material structure according to the present invention could not be manufactured directly on Ni metal and an example in which a PZT brittle material structure according to the present invention was manufactured by depositing an Au sputtered film on Ni metal.

### DESCRIPTION OF EMBODIMENTS

It is well known that oxide ceramics are easily affected by residual stress acting inside because of their high Young's modulus and very high hardness in general.

However, it is known that in the conventional manufacturing methods accompanied by heat treatment such as sputtering method, PLD method, CVD method, MOD (sol-gel) method, hydrothermal synthesis method, screen printing, EPD (Electrophoretic Deposition) method, and Cold Sintering, even if deposited at temperatures lower than sintering temperature, residual stress occurs in oxide ceramics film due to slight linear expansion coefficient differences between the substrate and oxide ceramics film, leading to performance degradation of piezoelectric and dielectric properties.

Even in the ceramics film deposited at room temperature such as AD method, internal compressive stress by shot peening effect becomes residual stress, and leads to degradation of the dielectric property which is a problem.

In the oxide all-solid-state lithium-ion secondary battery, the internal stress changes due to expansion and contraction due to insertion and desorption of lithium ion in the active material. As a result, there is a problem that the active material itself is cracked, which leads to performance deterioration.

The polarization mechanism in ferroelectrics that exhibit large piezoelectricity comes from the fact that the domain walls formed due to the anisotropy of the crystal move when a high electric field is applied, and polarization reversal or polarization rotation is achieved. However, when there are areas where the interface is not clean, the crystallinity is incomplete (lattice images observed by TEM are unclear), or there are oxygen defects, the domain wall movement is pinning or clumping, and sufficient polarization reversal and rotation cannot be achieved. As a result, it is known that the ferroelectric property and the piezoelectric property are deteriorated. Therefore, it is necessary to synthesize oxide having high crystallinity and few defect.

Similarly, in the oxide solid electrolyte, lithium ions move mainly along the conduction path formed in the crystal. When there is a portion with incomplete crystallinity or a binder that does not show the ionic conductivity of lithium ions between the particles, the ionic conductivity will decrease. Therefore, it is required to obtain high-quality crystals.

When low-temperature deposition is performed using conventional techniques such as sputtering, PLD method, CVD method, MOD (sol-gel) method, hydrothermal synthesis, screen printing, EPD method, cold sintering, which promote crystal growth to obtain highly dense films, it is very difficult to obtain high crystallinity and the substrate material is quite limited.

The AD method can deposit a film using high-quality oxide ceramics raw material fine particles. However, the miniaturization of the raw material fine particles peculiar to the AD method leads a size effect in which the piezoelectric property and the dielectric property are lowered. The oxide solid electrolyte also has a problem that many grain boundaries are formed as a barrier when lithium ions move, and the ionic conductivity is lowered.

Furthermore, with means such as the hydrothermal synthesis method and the EPD method, in which a ceramics film is deposited in an aqueous solution, hydroxyl groups and the like remain at the grain boundaries. Therefore, it is also known as a problem that the leakage current of the ferroelectric substance increases and the lithium ion conduction is hindered.

Ceramics deposition techniques, such as sputtering method, PLD method, CVD method, MOD (sol-gel) method, hydrothermal synthesis method, screen-printing, and EPD method, are techniques for depositing an oxide ceramics film on a substrate. However, in the case of all-solid-state lithium-ion oxide secondary battery, it is necessary to form highly dense ceramics film between aluminum and copper foil, which is current collector, without the use of a binder. Therefore, a new deposition method is required to enable bonding different from the conventional ceramics deposition technique.

In the AD method, facing the deposited sulfide solid electrolytes and pressurizing them, the bonding accompanying the high densification of the sulfide solid electrolyte layer is realized (Japanese laid-open patent publication No. 2016-100069). However, when applied to an oxide solid electrolyte in which lithium ions migrate within the crystal, the grain boundaries, which act as a barrier to the migration of lithium ions, are formed in large numbers as a result of miniaturization.

As a result, it is difficult to bond the raw material particles without crushing them. In addition, a method capable of highly dense deposition in atmospheric pressure is desired rather than vacuum process such as sputtering method, PLD method, CVD method, or an AD method, or decompression process.

Unlike conventional deposition method such as sputtering method, PLD method, CVD method, MOD method (sol-gel method), hydrothermal synthesis method, screen-printing method, and EPD method with crystal growth by heat treatment, it was difficult to achieve a relative density of 80% or more (a relative porosity of 20% or less in terms of porosity) of a structure without pulverizing raw material fine particles in a pressure molding method in which a structure was obtained by pressing a metal mold with raw material fine particles, as shown by Yoshio Uchida, Sumitomo Chemical 2000-I, Sumitomo Chemical, published May 25, 2000, pp. 45-49.

Generally, any fine particles of oxide ceramics necessarily have “cohesive bonding force”. It is known that when the fine particle becomes smaller and the specific surface area becomes wider, its binding force works strongly, so that it tends to cohere easily. In the conventional pressure molding method, before the voids are filled with fine particles, a binding force that coheres the fine particles works, and a strong frictional force due to the molding pressure is also applied. Therefore, it was not possible to manufacture a highly compacted structure. Similar to the AD method, a method with the crushing of raw material fine particles has been adapted to produce structures with a relative density of 80% or more (porosity of 20% or less) by pressure molding (Japanese laid-open patent publication No. 2006-043993).

Cold Sintering method is a method for manufacturing a highly dense oxide ceramics by providing amorphous layers around raw material fine particles and applying pressure. The non-heat treatment may leave an amorphous layer around the raw material fine particles, resulting in a decrease in piezoelectric, dielectric, and ionic conductivity. As a result, the amorphous layer may need to be heat treatment to grow into high quality crystal. In addition, there is problem that the raw material fine particles capable of forming the amorphous layer is limited.

A nano-sheet in which oxide is thinly separated (Japanese laid-open patent publication No. 2012-240884) can deposit a layer of a dense oxide without heat treatment. However, since oxide sheets having a thickness of several nm are deposited one layer at a time, depositing a sheet to a thickness of about submicron is difficult.

Similarly, recently, a technique for arranging cube-shaped nanoparticles regularly in three dimensions has attracted attention (Japanese laid-open patent publication No. 2012-188335). Indeed, it is difficult to provide a uniform film without gaps on the substrate because cracks occur over a wide range due to a slight difference in size of the cube-shaped raw material fine particles.

### <Brittle Material Structure According to the Present Invention>

The structure according to the present invention is a brittle material structure having the following features. The powdered raw material fine particles of a highly crystalline brittle material manufactured at high temperature are pressed into a thin layer. Among the “cohesive forces” and “frictional forces” that act before the raw material fine particles fill the voids, the “cohesive cohesion force” and “frictional force” acting in the perpendicular direction of the surface are suppressed to promote the flow of the raw material fine particles, forming a structure in which the raw material fine particles are highly densely arranged. Furthermore, the structure is manufactured by stacking the structure with the same highly densely packed raw material fine particles on top of the structure in a pressurized formation so that they are integrated, and cohering the particles. The brittle material structure can have the relative density is 80% or more (porosity of 20% or less) and Vickers hardness of HV250 or less.

### <Raw Material Fine Particles>

It is preferred that the brittle material structure includes a void formed between the first particles and the first particle, and a second particles filling the void.

### <Mixing Ratio of the Fine Particles>

The percentage of the mixing ratio of the second particles in the brittle material structure (volume occupied by the second particles/volume occupied by the first and second particles) is preferably between 15% and 60%.

### <Particle Size Ratio>

The ratio of the size of the second particles to the first particles (the ratio of particles diameter size of the second particles to particle diameter size of the first particles) included in the brittle material structure is preferably 0.75 or less. When the second particles contain raw material fine particles having different average particle diameters, the raw material fine particles having the largest particle size is designated as the third particles. When the third particles are included in the structure, the ratio of the size of the third particles to the first particles is preferably 0.75 or less.

### <Size of the Second Particles>

The size of the second particles contained in the brittle material structure is preferably 3 μm or less.

### <Minimum Size of First Particles>

Particle diameter size of the first particles included in brittle material structure is preferably 100 nm or more.

### <Porosity>

In a preferred embodiment of the present disclosure, the relative density of the brittle material structure is preferably 80% or more (porosity of 20% or less). For example, the relative density can be obtained by the brittle material structure including the above-mentioned voids formed between the first particles, and the second particles that fill the voids.

### <Vickers Hardness>

It is considered that the bonding force between the raw material fine particles in the above-mentioned brittle material structure are dominated by the inherent cohesive bonding force of the oxide ceramics particles, which inhibits the flow of the raw material fine particles and hinders the filling of the voids in the conventional pressurized molding method. Therefore, compared with a sintered body produced by growing crystals by conventional heat treatment, a ceramics film produced by heat treatment by sputtering, PLD method, CVD method, MOD (sol-gel method) method, hydrothermal synthesis method, screen printing, EPD method, or the like, or a densified ceramics film obtained by crushing raw material fine particles by applying mechanical shock, such as AD, it is considered that the brittle material structure provided by the present invention has characteristic of low Vickers hardness even though the relative density (porosity) is the same. It is preferable to provide features that function to prevent the accumulation of residual stress generated inside structure by bonding between raw material fine particles by this weakly aggregating bonding force.

### <Substrate>

The brittle material structure is preferably provided on a metal or carbon substrate having a sufficiently low elastic modulus to allow the brittle material to adhere thereto when pressurized. From this viewpoint, it is preferred that brittle material is provided on a metal or carbon substrate having an elastic modulus of 180 GPa or less. When the elastic modulus of the substrate is 180 GPa or more, it is preferable to sandwich a metal or carbon layer having an elastic modulus of 180 GPa or less between the substrate and the structure. The thickness of the layer of metal or carbon is preferably 20 nm or more.

### <Bonding>

When the brittle material structure is provided between two metal or carbon layers and the two metal or carbon layers are bonded by the structure, the two metal or carbon layers are preferably metal or carbon layers having an elastic modulus of 180 GPa or less, respectively.

### EXAMPLES

### <Example 1> A Structure According to the Present Invention Using Alumina Particles

Next, a preferred specific manufacturing method of the structure according to the present invention will be described. As shown in FIG. 1A, only the first particles are adhered to the surface of a substrate having a high elastic modulus (hereinafter referred to as “transfer plate”). SUS304 (film thickness: 20 μm) used as a transfer plate. Sumicorundum AA3 (particle diameter size: 3 μm) produced by Sumitomo Chemical used as the first particles. The quantity of the first particles calculated on the basis of the thickness of structure to be produced. Weighing the first particles with a micro analytical balance (SHIMADZU, MODEL: AEM-5200), transferring to a 50 cc glass container containing ethanol, dispersion treatment was performed with ultrasonic waves of 350 W and 20 kHz for 1 minute using an ultrasonic homogenizer (SONIC & MATERIALS, MODEL: VCX750). Then, the solution was transferred to an airbrush coating system (PS311 airbrush set produced by GSI Creos) and spray-coated on the SUS304 of the transfer plate prepared in advance on a hot plate set at 80° C. FIG. 2A is a surface SEM image the transfer plate, and FIG. 2B is a surface SEM image of the transfer plate to which the first particles are adhered. When viewed from the top surface, it is preferred that the first particles cover 40% or more of the transfer plate.

After spray painting, a part of the substrate was hollowed out as a mark and the weight of the first particles deposited on the SUS304 was measured using the micro analytical balance.

The method of adhering the first particles to the transfer plate is not limited to the following. The following methods are mentioned as methods for adhering the first particles to the transfer plate; for example, the aforementioned “spray painting method” in which a solution of the first particles dispersed in an organic solvent is sprayed and dried; the “sedimentation method” in which the solution of the first particles dispersed in the organic solvent and the transfer plate are placed and the first particle is allowed to settle or the solvent is allowed to volatilize and the first particles are allowed to adhere to the transfer plate; the “EPD method” in which the first particles are adhered to the transfer plate by electrophoresis, the “screen printing method” using a doctor blade, and the like.

Next, as shown in FIG. 1B, the mixing ratio of the second particles (volume occupied by the second particles/volume of the first particles and the second particles combined) is within the range of 15% to 60%, it is preferable to adhere the second particles onto the first particle. The method of spray coating the second particles is the same as the method of spray coating the first particles. As the second particles, Sumicorundum AA03 (particle size: 300 nm) produced by Sumitomo Chemical and Al₂O₃ nanoparticles (particle size: 31 nm) produced by CLK Nanotech were used. The mixing rate of the second particles is 25%, and the mixing ratio of AA03 and Al₂O₃ nanoparticles is 18.75:6.25. A surface SEM image of the second particles on the first particle is shown in FIG. 2C, and a cross-sectional SEM image is shown in FIG. 2D. The second particles permeate the voids formed of the first particles and reaches the transfer plate. It is preferable that the upper part has a high density of the second particles and the transfer plate side has a feature that the first particles are mainly in contact with each other.

The transfer plate of SUS304 coated with the first particles and the second particles removed from the hot plate and hollowed out in the form of a disk having a 1 cm² cp. As shown in FIG. 1C, the coated raw material fine particles opposed to a metal or carbon substrate having an elastic modulus of 180 GPa or less. As shown in FIG. 1D, the raw material fine particles pressed against the substrate and solidified. An aluminum foil having a thickness of 20 μm was used as the substrate. The solidification pressure is preferably below the pressures at which the raw material fine particles are crushed, and solidification pressure is below 2 GPa. The manufacturing device for pressing the raw material fine particles against the substrate was used a uniaxial pressurized press as shown in FIG. 3A. The manufacturing device of pressing the raw material fine particles against the substrate is not limited to the following. A substrate uniaxial pressing machine shown in FIG. 3A, or roll press machine shown in FIG. 3B is used as a manufacturing device for pressing raw material fine particles against the substrate. As solidification pressure, it was pressurized by two ways of 420 MPa and 925 MPa. When the raw material fine particles are pressed against the substrate, the lateral vibration may be applied. The lateral vibration was applied by an ultrasonic homogenizer (SONIC & MATERIALS, MODEL: VCX750) with ultrasonic waves of 350 W and 20 kHz for 3 seconds.

As shown in FIG. 1D, it is preferable to push the raw material fine particles into the metal or carbon substrate by applying the solidification pressure. At that time, it is preferred that the first particles are densely arranged and the second particles are densely arranged in the void formed by the first particles and the first particles. Although the substrate, the first particles and the second particles are in intimate contact, the contact between the raw material fine particles (mainly the first particles) and the transfer plate is preferably coarse. Therefore, as shown in FIG. 1E, it is preferred that the transfer plate can be peeled off while leaving most of the raw material fine particles composed of the first particles and the second particles on the substrate. Hereinafter, the manufacturing process of transferring the raw material fine particles from the transfer plate to the substrate will be referred to as “transfer film formation”. FIG. 2E is a surface SEM image of the transfer plate after the transfer film formation. It is shown that the first particles do not remain and a small amount of the second particles remain. At this time, the transfer rate was 98% or more.

Similarly, as shown in FIG. 1F to FIG. 1H, a solidification pressure is applied to the raw material fine particles adhering to the transfer plate. It is preferable that the raw material fine particles adhering to the substrate are densely and uniformly arranged and deposited on the substrate with high density. It is preferable to stack highly dense ceramics film by repeating the steps of FIG. 1F to FIG. 1H.

FIG. 4A shows a fractured surface of a self-supporting film which is peeled from an aluminum foil of a substrate after the transfer film formation on the aluminum foil at a solidification pressure of 420 MPa. The number of times of the transfer film formation was 10. The relative density reached 87% (with a porosity of 13%). According to FIG. 4A, it can be observed that the first particles are densely arranged and the second particles are densely arranged to fill the gap. The brittle material structure is confirmed to be a seamlessly integrated and laminated the brittle material structure between the transfer film and the transfer film. FIG. 4B is a cross-sectional SEM image of a sample transferred to an aluminum foil at a solidification pressure of 925 MPa, subjected to resin filling treatment, and cut and polished. The relative density was 95% (with a porosity of 5%). The number of times of the transfer film formation is 8. An anchor layer is formed on the aluminum foil of the substrate by the raw material fine particles, and no seam is observed due to the stacking process, and it can be confirmed that the material structure is an integrated brittle material.

The method for calculating the relative density (porosity) of the sample of the transfer film formation is described. Before the transfer film formation, the weight of the substrate is measured with the micro analytical balance (SHIMADZU, MODEL: AEM-5200). After the transfer film formation, the weight is measured again with the micro analytical balance, and the weight of the substrate measured in advance is subtracted to obtain the weight of the film. The specimens that were transferred and formed on the substrate were resin-filled (using Technovit 4004), cut through the center of the structure and mirror-polished. The mirror-finished surface is sputtered with gold to a thickness of about 5 nm (QUICK COTER, MODEL: SC-701HMCII produced by SANYU ELECTRON). The cross-sectional thickness of the structure was measured at 60 to 100 locations using a SEM (JOEL MODEL: JSM-6060A) and the average value was taken as the film thickness to calculate the density of the structure. The true density of alumina was 4.1 g/cm³ and the relative density was obtained as percentage. The porosity (%) was calculated by subtracting the relative density (%) from 100%.

The transcription rate is the percentage of the raw material fine particles transferred from the transfer plate to the substrate. After the above-mentioned raw material fine particles were coated on the transfer plate, the weight of the sample hollowed out in a disk shape at 1 cm²φ was measured with the micro analytical balance (SHIMADZU, MODEL: AEM-5200). This is referred to as “weight (1)”. Then, the transfer film formation was performed and transfer plate was reweighed on the micro-analytical balance with raw material fine particles remaining. This is referred to as “weight (2)”. Further, the raw material fine particles remaining on the transfer plate were wiped off with a waste cloth, and then the weight of the transfer plate of 1 cm²φ was measured. This is referred to as “weight (3)”. The transcription rate was calculated from these three weights as follows.

Weight (1)−Weight (2)/(Weight (1)−Weight (3))×100(%)

As will be described later, at a press pressure of 1 GPa or less, the oxide ceramics raw material fine particles such as PZT, alumina, and barium titanate do not adhere to SUS304, and all the raw material fine particles remaining after the transfer film formation can wiped off with a waste cloth.

The ceramics material applicable to the present invention is not limited to the following. Examples of the ceramics material include a lithium ion secondary battery positive electrode active material such as alumina, silicon oxide, PZT, barium titanate, titanium oxide, and lithium cobaltite, a lithium ion secondary battery negative electrode active material such as lithium titanate, and an oxide solid electrolyte such as Li—Al—Ge—P—O.

Next, the relationship between the thickness and the relative density of alumina according to conventional pressure molding method using mold will be described. FIG. 5 shows a manufacturing apparatus of a pressure molding method using a conventional mold. The mold composes of a cylinder and two pins. Put the raw material powder in a cylinder and apply pressure to the pins to compact the powder. The cylinder and the pin were made by applying 20 μm of hard chrome plating to SKD11. The inner diameter of the cylinders is 1 cm². The Sumicorundum AA3 (particle diameter: 3 μm) produced by Sumitomo Chemical was used as raw material fine particles.

First, the height of the two pins was measured with nothing in the mold, one pin was removed from the cylinder, the alumina raw material powder was placed in a mold, the pin was sealed again, and the mixture was pressured by applying a uniaxial pressurization of 925 MPa, and then the weight of the alumina raw material powder was measured. With the compacted alumina in the mold, the height of the pins was measured, and the height of the pins of the mold measured in advance was subtracted. As a result, the thickness of the compacted alumina was obtained, and the relative density was calculated from the ratio with the weight of the alumina raw material powder. Alumina compacted to a thickness of less than 300 μm collapsed simply by removing the pin from the cylindrical mold.

FIG. 6 shows the relationship between the thickness and the relative density of the compacted alumina. The alumina sample compacted to a thickness of more than 300 μm showed a relative density equivalent to that of Japanese laid-open patent publication No. 2016-100069. The relative density of the alumina sample was improved when it became thinner than about 150 μm. It was confirmed that the relative density of the alumina sample rapidly improved at around 100 μm (about 30 to 40 particles in the thickness direction). Further thinning the film is expected to improve the relative density to about 74% to 75%.

This result suggests that if the number of the raw material fine particles in the thickness direction is small, the cohesive force to cohere is weakened and the raw material fine particles can be arranged densely. Only particle having an average particle size of 3 μm is used as the raw material fine particles. Therefore, when the remaining 25% to 26% voids are similarly filled with the raw material fine particles, which have a mean particle diameter well below 3 μm, the relative density is likely to increase to approximately 93%. However, since the thin pressed alumina is not subjected to heat treatment, bonding between the raw material fine particles are dominated by cohesive bonding force, and the alumina is very brittle and easily collapsed. Therefore, it is not easy to even remove the pin from the cylinder so as not to break the compacted alumina.

Next, the relationship between the solidification pressure and the relative density will be described. The relationship between the solidification pressure and the relative density is shown in FIG. 7. In a structure of alumina produced by the transfer firm formation, Sumicorundum AA3 (particle diameter size: 3 μm) produced by Sumitomo Chemical were used as the first particles, and Sumicorundum AA03 (particle diameter size: 300 nm) produced by Sumitomo Chemical and Al₂O₃ nanoparticles (particle diameter size: 31 nm) produced by CLK Nanotech were used as the second particles. The mixing rate of the second particle is 25%, and the mixing ratio of AA03 and Al₂O₃ nanoparticle is 18.75:6.25. An aluminum foil having a thickness of 20 μm was used as the substrate. As a comparative reference, the results of the relative density of alumina (thickness: 300 to 400 μm) pressed using the mold at the same mixing ratio of the first particles and the second particles are also described.

The thickness obtained by each transfer was about 5 to 10 μm, and the number of transfers was 4 to 10. The thickness of the structure is 30 μm to 50 μm. By applying a low pressure of 250 MPa as the solidification pressure, the relative density exceeded 80%. On the other hand, in the press molding method using conventional dies, even when the pressure of 1 GPa was applied, the relative density did not exceed 80%. This result is equivalent as in Japanese laid-open patent publication No. 2016-100069. Even at the same molding pressure, by laminating a thin layer, it can be confirmed that the relative density is improved about 20%.

Next, the relationship between the mixing ratio and the relative density of the second particle. FIG. 8 shows the relationship between the mixing rate of the second particles and the relative density will be described. The solidification pressure was 925 MPa. An aluminum foil having a thickness of 20 μm was used as the substrate. Sumicorundum AA3 (particle diameter: 3 μm) produced by Sumitomo Chemical was used as the first particles, and Sumicorundum AA03 (particle diameter size: 300 nm) produced by Sumitomo Chemical was used as the second particles. The mixing ratio of the second particles was 15% to 60%, and the relative density exceeded 80%.

The relationship between the mixing ratio of the second particles and the relative density will be described. FIG. 9 shows the relationship between particle diameter size of the second particles and the first particles and the relative density. The mixing rate of the second particle is 25%, the press pressure is 925 MPa. An aluminum foil having a thickness of 20 μm was used as the substrate. As the raw material fine particles, Sumicorundum AA03 (particle diameter size: 300 nm), AA07 (particle diameter size: 700 nm), AA3 (particle diameter size: 3 μm) produced by Sumitomo Chemical and Al₂O₃ nanoparticles (particle diameter size: 31 nm) produced by CLK Nanotech were used. By setting particle diameter size ratio to 0.75 or less, the voids formed between the first particles can be filled with the second particles so that the relative density of the structures exceeds 80%, i.e., the void ratio is less than 20%.

This section describes the effect of lateral vibrations when the solidification pressure is applied to the relationship between the number of times of the transfer film formation and the transcription rate. Sumicorundum AA3 (particle diameter: 3 μm) produced by Sumitomo Chemical was used as the first particles. Sumicorundum AA03 (particle diameter: 300 nm) produced by Sumitomo Chemical, and Al₂O₃ (particle diameter: 31 nm) produced by CLK Nanotech were used as the second particles. The mixing rate of the second particles is 25%, and the mixing ratio of AA03 and Al₂O₃ nanoparticles is 18.75:6.25. An aluminum foil having a thickness of 20 μm was used as the substrate. The solidification pressure was 200 MPa. The results are shown in FIG. 10. The transcription rate results of the alumina structures produced are shown for the case where lateral vibrations by ultrasonic waves are applied or not while raw material fine particles are transferred and formed on the substrate by adding solidification pressure. As the substrate, an aluminum foil having a thickness of 20 μm was used. The lateral vibrations were applied with an ultrasonic homogenizer (SONIC & MATERIALS Inc., MODEL: VCX750) by pushing it against the substrate-mounted pedestal for 3 seconds at 350 W and 20 kHz. In the case where lateral vibration is not applied to the substrate, the transcription rate gradually decreases every time the number of times of transfer film formation is increased. By applying lateral vibration to the substrate, there is an effect of maintaining a high transcription rate.

The influence of the size of the first particles on the relationship between the number of times of transfer film formation and the transcription rate will be described. FIG. 11 shows the relationship between transcription rate and number of transfers for brittle material structure produced using alumina raw material fine particles (Sumicorundum produced by Sumitomo Chemical) with mean particle diameter of 3 μm and 300 nm and 31 nm, respectively, and alumina raw material fine particles (Sumicorundum produced by Sumitomo Chemical) with mean 300 nm and 31 nm, respectively. An aluminum foil having a thickness of 20 μm was used as the substrate. The mixing rate of the second particles is both 25%. It is possible to confirm the characteristic of high transcription rate when it contains as many large particles as possible. This is due to the fact that the bonding of the raw particles is strongly dependent on the cohesive bonding force. The smaller the first particles, the larger the specific surface area per unit volume, the wider the contact area between the transfer plate and the raw material fine particles, and the greater the force that binds the transfer plate and the raw material fine particles. As a result, it is considered that the transcription rate decreases as the number of transfers increases. The size of the first particles is preferably greater than 100 nm.

Next, the influence of the mode of the first particle and the second particle formed on the transfer plate on the transcription rate will be described. FIG. 12-1 and FIG. 12-2 show the relationship between the number of times of transfer film formation and transcription rate depending on the way the various raw material fine particles are arranged. Alumina (Sumicorundum produced by Sumitomo Chemical) was used as the raw material fine particles. The average particle size of the first particles is 3 μm, and the average particle size of the second particles is 300 nm. The mixing rate of the second particles was 25%. An aluminum foil having a film thickness of 20 μm was used as the substrate.

As shown in FIG. 12-1A, the second particles were stacked on the first particles by the process according to FIG. 1A to FIG. 1H. It was shown that a high transcription rate of 98 to 99% could be maintained even if the number of times of the transfer film formation increased.

FIG. 12-1B is an example in which a film containing the second particles is transferred and formed on a substrate, and then a film containing the first particles is transferred and formed. FIG. 12-1C shows the result of the transfer film formation of only a film containing the raw material fine particles having an average particle size of 300 nm. As shown in FIG. 12-1C, since the second particle has a large specific surface area of the raw material fine particles, it has strong binding force to cohere. Therefore, the second particles are easily adhered to the transfer plate, and the transcription rate is low. On the other hand, as shown in FIG. 12-1B, the film containing the second particles that was initially transferred and formed have a lower transcription rate as in FIG. 12-1C. In the transfer film formation of the film containing the next first particles, since the specific surface area is smaller than that of the second particles, the bonding force is smaller than that of the second particles and is well bonded to the film containing the second particles which transferred and formed on the substrate. On the other hand, the second particles showed a very high transcription rate because it did not easily adhere to the transfer plate. However, a film containing the second particles subsequently transferred tends to adhere to the transfer plate as well. Therefore, when transfer plate was peeled off, the second particle was also bonded to the structure on the substrate. The structure was broken in the peeling process after the third transfer film was formed.

FIG. 12-2D shows the relationship between the transcription rate and the number of times of the transfer film formation when the film of the mixed structure was transferred and formed on the transfer plate by mixing the first and second particles and spray-painting it. Although a transfer film can be formed, the difference between “the adhesion force between the raw material fine particles and substrate” and “the adhesion force between the raw material fine particles and the transfer plate” is smaller than the stacked structure shown in FIG. 12-1A. Therefore, it is considered that the transcription rate tends to decrease as the number of times of transfer film formation is repeated, and the structure is gradually broken.

FIG. 12-2E shows the relationship between the transcription rate and the number of times of the transfer film formation when a film having a mixed structure of FIG. 12-1D is deposited on the stacked structure of FIG. 12-2A and then transfer film formation is performed. The first transfer film formation process showed a good transcription rate. It is considered that in the second transfer film formation process, a layer having a high concentration of the first particles having a small specific surface area was formed, and thus the transcription rate is greatly lowered. The structure was broken in the peeling process after the third transfer film was formed.

FIG. 12-2F shows first particles are spray-coated (first particle layer) on the transfer plate, a layer obtained by mixing the first particles and the second particles is spray-coated thereon (mixed particle layer, the mixing rate of the second particle is 25%), and the second particle is spray-coated thereon (second particle layer) so that the mix rate of the second particles is 25% as compared with the first particle layer, and the relationship between the transcription rate and the number of times of transfer film formation. In the fourth transfer film formation process, the transcription rate is 98%, and it is considered that a thick and uniform the brittle material structure can be produced.

Next, the specific surface area in which the structure can be manufactured will be described. In the structure according to the present invention, it is considered that the bonding between the raw material fine particles is dominated by the inherent cohesive bonding power of the material. Therefore, it is considered that the success or failure of the production of the structure also depends on the specific surface area of the raw material fine particles used. The structure is manufactured on an aluminum foil with a film thickness of 20 μm using the alumina raw material fine particles with an average diameter of 18 μm for the first particles (Sumicorundum AA18 produced by Sumitomo Chemical) and the alumina raw material fine particles with an average diameter of 5 μm for the second particles (Sumicorundum AA5 produced by Sumitomo Chemical). The structure is manufactured on an aluminum foil with a film thickness of 20 μm using the alumina raw material fine particles with an average diameter of 18 μm for the first particles (Sumicorundum AA18 produced by Sumitomo Chemical) and alumina raw material fine particles with an average diameter of 2 μm for the second particles (Sumicorundum AA2 produced by Sumitomo Chemical).

These structures were sprayed with cleaning gas at a distance of 11 cm from each other. The mixing rate of each second particle was 25%, and the solidification pressure was 925 MPa.

As a result, most of the structure using 5 μm particles as the second particles were blown away, and the film structure could not be maintained. However, the structure using 2 μm particles as the second particles maintained the shape of the film (FIG. 13). It is considered that the size of the specific surface area of the second particles for filling the void formed between the first particle and the first particle is related to the strength of the structure. In addition, at the solidification pressure of 925 MPa, the alumina raw material fine particles are not crushed, and no cracks were observed in the fine particle forming the structure. Therefore, in the brittle material structure according to the present invention, it is considered that the size of the second particle is 3 μm or less.

Next, the structure including the binder and the like will be described. The structure according to the present invention preferably has feature that do not require the binder, but the effect of including binder was also investigated.

Sumicorundum AA3 (particle diameter: 3 μm) produced by Sumitomo chemical was used as the first particles. Sumicorundum AA03 (particle diameter: 300 nm) produced by Sumitomo chemical was used as the second particles. PTFE produced by Nagoya Synthesis Co., Ltd. was used as binding material.

The mixing rate of the second particle was adjusted to 25%, and PTFE was adjusted to be contained in the structure at a weight ratio of 100 ppm. The raw material fine particles were dispersed in ethanol and adhered to the transfer plate by spraying. The solidification pressure was 925 MPa. SUS304 was used as the transfer plate, and an aluminum foil having a thickness of 20 μm was used as the substrate. Lateral vibration was applied for 3 seconds with an ultrasonic homogenizer while applying pressure during the transfer film formation. The following three types of stacking methods were tried. (1) The AA3 was adhered to the transfer plate, the AA03 was adhered thereon, the PTFE was adhered thereon, and transfer film formation was repeatedly performed. (2) AA3 was adhered to the transfer plate, AA03 carrying the PTFE was adhered thereon, and transfer film formation was repeatedly performed. (3) The AA3 was adhered to the transfer plate, and AA03 was adhered thereon, and PTFE was adhered on top of the obtained structure by transfer film formation, and then the next transfer film formation was repeatedly performed. FIG. 14 is a graph showing the influence of the modes of these three methods on the relationship between the number of times of transfer film formation and the transcription rate.

In any method, it was confirmed that the transcription rate was lowered by repeating the transfer film formation. The relative density of the obtained structure was also 80%, and the density was reduced by including PTFE. On the other hand, it was confirmed that, in a solution in which fine alumina powder and PTFE are dispersed in ethanol, the fine alumina powder hardly settles compared with a case where no PTFE is added, and PTFE functions as a dispersing material. It is considered that the function of PTFE as a dispersant caused a decrease in the density of the structure and a decrease in the transcription rate.

From these results, it is considered that in the present manufacturing process, a structure having a relative density of 80% or more can be obtained even if the binding material is included at 100 ppm (probably even if 0.1% or less is included). Since the binding material functions as a dispersing material during production, it is expected to be effective in facilitating handling of fine particles. Further, by selecting 2 types of binding material such that the polarity of the surface charges of the first particles and the second particles is opposite, when raw material fine particles are dispersed in a solvent such as ethanol, binding material functions as a dispersing material, and sedimentation of raw material fine particles can be suppressed. On the other hand, when a transfer film is formed, it can be expected to function as a flocculant for promoting the flocculation of particles to form a strong film. The binder applicable to the present invention is not limited to the following. Examples of the binding material include vinyl resins such as PVA, PVB, and PVC, polystyrene resins such as EVA, PS, and ABS, acrylic resins such as PMMA, and fluoro resins such as PVDF, PTFE, and ETFE.

### <Example 2> A Structure According to the Present Invention Using Ferroelectric Particle (PZT, Barium Titanate)

The method for manufacturing the raw material fine particles of PZT is described. PZT-LQ produced by Sakai Chemical, sodium chloride, and potassium chloride were ground and mixed with a wet planetary ball mill process using acetone, and PZT was grown to grains by heat treatment at 1200° C. for 4 hours. Sodium chloride and potassium chloride contained in the obtained sample were dissolved in pure water to wash PZT particle. The obtained PZT particles were dried at 800° C. for 1 hour. PZT raw material fine particles are referred to as “PZT-A”.

PZT-LQ produced by Sakai Chemical was pressurized into pellets, sintered at 1200° C. for 4 hours, ground by planetary ball milling with ethanol, and dried at 80° C. The obtained powder was placed in ethanol and dispersed by an ultrasonic homogenizer (SONIC & MATERIALS, MODEL: VCX750) at 350 W, 20 kHz for 5 minutes. A table-top centrifuge (Kubota Shoji 8420) was used to extract the settled coarse particles at 600 rpm. PZT raw material fine particles dried at 600° C. for 1 hour is referred to as “PZT-B”. The coarse particles were settled and removed at 1500 rpm, and then the settled particles were extracted at 2000 rpm. After drying treatment at 600° C. for 1 hour, the product is referred to as “PZT-C”. After drying treatment at 800° C. for 1 hour, the product is referred to as “PZT-D”.

FIG. 15A shows an SEM image of PZT-A used as the first particles and FIG. 15B shows a SEM image of the raw material fine particles of PZT-D used as the second particles. FIG. 16 shows an image of a structure produced by transferring and depositing PZT-A and PZT-D. The mixing rate of the second particles is 25%. The relative density was about 90%. The structure was very dense. The solidification pressure was 900 MPa. An aluminum foil having a thickness of 20 μm was used as the substrate. A film thickness of 11 μm was obtained by performing transfer film formation 20 times. As shown in FIG. 17A to FIG. 17C, it was confirmed that the transcription rate was high and the surface of the structure became a mirror surface by reflecting the surface shape of the transfer plate.

FIG. 17A and FIG. 17B show cross-sectional TEM images, and FIG. 17C shows a planer TEM image. In the cross-sectional TEM image, it can be observed that the raw fine material particles are densely arranged without being crushed. On the other hand, in the planar TEM image, some cracked particles were observed, but they did not seem to contribute to the high densification of the film. It was confirmed that the ratio of the cracked raw material fine particles was 10% or less.

FIG. 18A shows a TEM image of PZT-B. FIG. 18B shows a TEM image of a structure by the transfer film formation with PZT-B and PZT-C. The relative density of the structure shown in FIG. 18B was 93%. It is suggested that even if the raw material fine particles are not spherical such as corner or surface in shape, such as those obtained by crushing the sintered material, it is possible to tightly pack the raw material fine particles to produce a brittle material structure by the manufacturing method according to the present invention.

Next, the detailed TEM-observation results of structure produced by the transfer film formation are described. FIG. 19-1 is a TEM image of the structure produced by the transfer film formation using PZT-A as the first particles and PZT-D as the second particles. The mixing rate of the second particles was 25% and the solidification pressure was 900 MPa. FIG. 19-2 shows a structure manufacturing by transferring and depositing a barium titanate (BTO₃ produced by Sakai Chemical) with an average particle size of 300 nm to the first particles and a barium titanate (BaTiO₃ produced by Kanto Denka Kogyo) with an average particle size of 25 nm to the second particles (FIG. 19-2A), and a TEM image of the structure that was heat-treated at 600° C. (FIG. 19-2B). The mixing rate of the second particle is 25% and the solidification pressure was 750 MPa. As the substrate, an aluminum foil having a film thickness of 20 μm was used.

When the solidification pressure of the PZT structure is 900 MPa, a change is observed in the lattice image near the particle interface as compared with the lattice image in the grain. For barium titanate with a solidification pressure down to 750 MPa, this region of the lattice image change was reduced. It was observed that this region, which differs from the intergranular lattice image of the PZT structure, has a width of 40 nm or less across the particle interface.

FIG. 20 shows a schematic view of a region where the lattice has changed. Since the raw material fine particles are crystallized at high temperatures, they have “lattice-aligned layer”, which is a layer of lattices unique to the raw material fine particles. At the interface where the raw material fine particle flow and come into contact with each other, the regularity of the lattice may change with the flow, or the atomic arrangement may be disturbed. The “lattice flowing layer” formed by these changes in lattice regularity and atomic arrangement is thought to contribute to the agglomeration and bonding between the raw material fine particles.

Next, an example of bonding of a metal foil with ceramics fine particle will be described. Using PZT-B and PZT-C to produce two transfer film formed structure as 450 MPa of the solidification pressure on a copper foil having a thickness of 20 μm. PZT-B and PZT-C were spray-coated on the structures again, the coated surfaces were opposed to each other, and the structures were bonded at a solidification pressure of 450 MPa. FIG. 21A is an image of bonding the copper foil with PZT. FIG. 21B is a cross-sectional SEM image. According to the present invention, a brittle material structure having a feature in which copper foils are bonded by a dense PZT structure so that the bonding interfaces are integrated is manufactured. Since the solidification pressure is sufficiently lower than that of the above-mentioned example, it is considered that the raw material fine particles have not been miniaturized.

Next, the electric physical property of the structure of the PZT according to the present invention is shown. As the structure of PZT, PZT-A was used as the first particles and PZT-D was used as the second particles. The mixing rate of the second particles was 25%, and an aluminum foil having a film thickness of 20 μm was used as a substrate. The solidification pressure was 900 MPa. The relative density was 90%. For comparative reference, the electric physical properties of a sample in which PZT fine particles having a particle diameter of about 700 nm were pressure-molded at 900 MPa, a sample in which PZT fine particles having a particle diameter of about 100 nm were pressure-molded at 900 MPa, and a sample of PZT sintered at 1200° C. for 4 hours were evaluated.

FIG. 22A shows the leakage current characteristic. A sample obtained by pressure-molding PZT fine particles having a particle size of about 700 nm could not be evaluated because the leakage current value was too high. The leakage current characteristic of the brittle material structure of PZT according to the present invention was that the leakage current was 10⁻⁷ A/cm² or less even when a high electric field of 600 kV/cm was applied. It was confirmed that the sintered compact and the PZT fine particles having a particle diameter of about 100 nm have a characteristic exhibiting better insulating property than the pressure-molded sample.

FIG. 22B shows the polarization property of the brittle material structure of the present PZT. The history curve was well saturated and the residual polarization was 38 μC/cm². The residual polarization quantity of the sintered body produced by heat treatment at 1200° C. for 4 hours with the same raw material is 40 μC/cm². Therefore, it is considered that even aggregate can be made highly dense to provide sufficient functionality for electronic ceramics.

FIG. 23 shows the leakage current characteristic of a structure transferred and formed using PZT-A and PZT-D which have been stored in the air for six months after the synthesis, and a structure transferred and formed using PZT-A and PZT-D for one week or less after the synthesis. The leakage current value of the sample after half a year was higher than that of the sample within one week after synthesis. It is considered that this is because the electron conductivity on the surface is increased due to the adhesion of hydroxyl groups and carbonates on the surface of the raw material fine particles. The hydroxyl groups and carbonates adhering to the surface of the raw material fine particles are preferably provided so as to be 100 ppm or less by weight.

The mechanical property of the structure of PZT and alumina produced in accordance with the present invention will be described. In the structure of PZT, PZT-A was used as the first particles, and PZT-D was used as the second particles. An aluminum foil having a mixing rate of the second particles of 25% and a film thickness of 20 μm was used as a substrate. The solidification pressure was 900 MPa. In the alumina structure, the size of the first particles is 3 μm, the size of the second particles is 300 nm, and the mixing rate of the second particles is 25%. An aluminum foil having a thickness of 20 μm was used as the substrate. The solidification pressure was 925 MPa. As a comparative reference, PZT sintered body sintered by heat treatment at 1200° C. for 4 hours and a commercially available α-alumina substrate (purity 99.5%, manufacturing heat treatment temperature about 1600° C.) were prepared. The mechanical property and the Vickers hardness were evaluated using the dynamic micro hardness tester produced by Shimadzu Corporation. FIG. 24A shows the mechanical property of the alumina structure manufactured by the present invention and a commercially available alumina plate. FIG. 24B shows the mechanical property of PZT structure manufactured by the present invention and PZT sintered body.

Both the alumina structure according to the present invention and the commercial alumina substrate are dense with 99% relative densities. As shown in FIG. 24A, the commercial alumina substrate showed a typical ceramics history curve. However the alumina structure according to the present invention showed little “pushback” from the structure when the pressed indenter was removed. This result indicates that the inherent “cohesive bonding force” is the dominant factor in the bonding between the fine particles in the alumina structure produced by the present invention. It was suggested that the residual stress was easily relaxed and that it was a high-density aggregate different from the sintered body.

As shown in FIG. 24A and FIG. 24B, the sintered PZT is softer than the sintered alumina. Therefore, it is considered that PZT raw material particles was more easily in contact with each other face to face than the alumina raw material fine particles, and as a result, the PZT structure can bond more strongly between the particles than the alumina structure. Manufacturing conditions, relative density, and Vickers hardness are shown in Table 1 for the brittle material structures of PZT and alumina according to the present invention, as well as alumina and PZT sintered materials as reference samples. The brittle material structure according to the present invention exhibits lower Vickers harnesses than sintered body of the same relative density and preferably has HV250 or less.

TABLE 1

| | Solidification | | Relative | Vickers |
|---|---|---|---|---|
| | pressure | Solidification | density | hardness |
| Sample | (MPa) | temperature | (%) | (HV) |
| Almina film | 925 | room temuprature | 93 | 1.7 |
| Alumina sintered body | — | approximately 1600° C. | 99 | 1645 |
| (reference sanple) | | | | |
| PZT film | | room temuprature | 90 | 67 |
| PZT sintered body | | 1200° C. | 97 | 271 |
| (reference sanple) | | | | |

### <Example 3> Select of an Appropriate Substrate and the Transfer Plate Material

The elastic modulus of the substrate and the material used for the transfer plate, and the possibility of the transfer film formation process will be described. Table 2 shows the elastic modulus (Young's modulus) of various substrate candidates and the results of attempts at transfer film formation using PZT, barium titanate, and alumina. The transfer film formation was confirmed on a metal or carbon substrate having an elastic modulus of 180 GPa or less. On the other hand, it was clarified that the raw material fine particles hardly adhere to a metal substrate having an elastic modulus higher than 180 GPa. It is considered that the ceramics raw material fine particle and the substrate are in contact with each other without any gaps by elastically deforming the substrate to some extent at low pressures at which the raw material fine particles do not fracture. The brittle material structure is preferably provided on a metal or carbon substrate having an elastic modulus of 180 GPa or less. A metal substrate having an elastic modulus higher than 180 GPa is preferably used as transfer plate.

TABLE 2
Elastic modulus (Young's modulus) of the base material candidate and whether
or not film formation is possible at a solidification pressure of 900 MPa to 1 GPa

| | | | | PZT, Al₂O₃, BTO |
|---|---|---|---|---|
| | | | | whether film |
| base substrate | GPa | Mpsi | state | can be formed |
| Polycarbonate resin | 2.3 | 0.3 | single plate | Bat |
| PET | 2.8 to 4.2 | 0.4 to 0.6 | single plate | Bat |
| Glass epoxy | 20 to 24.3 | | single plate | Δ |
| carbon | approximately | 0.7 to 7.3 | Carbon coated aluminum foil | Good |
| (acetylene black) | 5 to 50 | | (SDX produced by Showa Denko) | |
| Al | 62 to 70 | 9.0 to 10.2 | single plate | Good |
| Au | 78 to 80 | 11.3 to 11.6 | Sputter film on Ni | Good |
| Brass | 103.0 | 14.9 | single plate | Good |
| Cu | 110 to 130 | 16.0 to 18.8 | single plate | Good |
| Pt | 146.9 | 21.3 | single plate | Good |
| SUS304 | 193.0 | 28.0 | single plate | Bat |
| Fe | 196.5 | 28.5 | single plate | Bat |
| Ni | 206.8 | 30.0 | single plate | Bat |
| Cr | 248.2 | 36.0 | 20 μm thick plating | Bat |
| | | | on quenching | |
| | | | SKD11 | |
| W | 345.0 | 50.0 | single plate | Bat |

FIG. 25 shows pictures of the structure when PZT was attempted to be deposited directly on the nickel substrate at 1 GPa solidification pressure and when 50 nm thick gold was sputtered onto the nickel substrate and then PZT was similarly deposited at 1 GPa solidification pressure. When trying to deposit PZT directly on the nickel substrate, the PZT is easily wiped off by the waste cloth. In contrast, a brittle material structure of PZT could be placed on a nickel substrate sputtered with gold. When a metal substrate with an elastic modulus higher than 180 GPa is used as a substrate material, a layer of metal or carbon of 180 GPa or less should be provided between the brittle material structure and the substrate material with an elastic modulus higher than 180 GPa by 20 nm or more.

### INDUSTRIAL APPLICABILITY

The brittle material structure according to the present invention can be used in a variety of applications in which conventional oxide ceramics is used. No heating treatment is required for its production, and internal stress is less generated. The brittle material structure is suitable for applications such as flexible device in which flexible organic substance such as plastic and electronic ceramics are combined, and oxide all-solid-state lithium-ion secondary batteries using oxide solid electrolyte and electrode material.

What is claimed is:

1. A brittle material structure comprising:
first brittle material particles; and
second brittle material particles having smaller size than the first brittle material particles,
wherein
a void formed between the first brittle material particles is filled with at least one of the second brittle material particles, at a porosity of less than 20%.

2. The brittle material structure according to claim 1, wherein a ratio of an average size of the second brittle material particles to an average size of the first brittle material particles is 0.75 or less.

3. The brittle material structure according to claim 1, wherein a ratio of a volume occupied by the second brittle material particles to a volume occupied by the first brittle material particles and the second brittle material particles is 15% to 60%, and an average size of the first brittle material particles is 100 nm or more, and an average size of the second brittle material particles is 3 μm or less.

4. The brittle material structure according to claim 2, wherein a ratio of a volume occupied by the second brittle material particles to a volume occupied by the first brittle material particles and the second brittle material particles is 15% to 60%, and an average size of the first brittle material particle is 100 nm or more, and an average size of the second brittle material particles is 3 μm or less.

5. The brittle material structure according to claim 1, wherein the brittle material structure has Vickers hardness of HV250 or less.

6. The brittle material structure according to claim 2, wherein the brittle material structure has Vickers hardness of HV250 or less.

7. The brittle material structure according to claim 3, wherein the brittle material structure has Vickers hardness of HV250 or less.

8. The brittle material structure according to claim 4, wherein the brittle material structure has Vickers hardness of HV250 or less.

9. The brittle material structure according to claim 1, wherein the brittle material structure has a stacked structure including brittle material layers composed of the first brittle material particles and the second brittle material particles, and
the brittle material layers are stacked.

10. The brittle material structure according to claim 2, wherein the brittle material structure has a stacked structure including brittle material layers composed of the first brittle material particles and the second brittle material particles, and
the brittle material layers are stacked.

11. The brittle material structure according to claim 3, wherein the brittle material structure has a stacked structure including brittle material layers composed of the first brittle material particles and the second brittle material particles, and
the brittle material layers are stacked.

12. The brittle material structure according to claim 4, wherein the brittle material structure has a stacked structure including brittle material layers composed of the first brittle material particles and the second brittle material particles, and
the brittle material layers are stacked.

13. The brittle material structure according to claim 5, wherein the brittle material structure has a stacked structure including the brittle material layers composed of the first brittle material particles and the second brittle material particles, and
the brittle material layers are stacked.

14. The brittle material structure according to claim 6, wherein the brittle material structure has a stacked structure including brittle material layers composed of the first brittle material particles and the second brittle material particles, and
the brittle material layers are stacked.

15. The brittle material structure according to claim 7, wherein the brittle material structure has a stacked structure including brittle material layers composed of the first brittle material particles and the second brittle material particles, and
the brittle material layers are stacked.

16. The brittle material structure according to claim 8, wherein the brittle material structure has a stacked structure including brittle material layers composed of the first brittle material particles and the second brittle material particles, and
the brittle material layers are stacked.

17. A manufacturing method of the brittle material structure comprising the steps of:
(i) adhering first brittle material particles on a transfer plate, and adhering second brittle material particles on the first brittle material particles to form a brittle material layer on the transfer plate, the transfer plate being a metal plate with a high enough elasticity modulus to prevent the brittle material layer from remaining on the metal plate in step (ii);
(ii) providing the substrate on a surface of the transfer plate on which the second brittle material particles are adhered, and transferring the brittle material layer adhered to the transfer plate onto the substrate by pressurizing the first brittle material particles and the second brittle material particles at a pressure lower than a pressure at which the first brittle material particles and the second brittle material particles are crushed, the substrate being composed of a metal or carbon with a low enough modulus of elasticity to allow the brittle material layer to adhere to the substrate during pressure transfer; and
(iii) adhering the first brittle material particles and the second brittle material particles to the transfer plate using the same process as in the step (i), and transferring the brittle material layer adhered to the transfer plate onto the brittle material layer on the substrate by placing the brittle material layer of the transfer plate on the surface of the transfer plate on which the second brittle material particles are adhered, and applying pressure to the brittle material layer on the transfer plate,
wherein a structure having a desired thickness and formed by cohering the first brittle material particles and the second brittle material particles on the substrate is formed by repeating the step (iii).

18. The method according to claim 17, wherein in the steps (ii) and (iii), applying vibration in a lateral direction of the transfer plate to transfer the brittle material layer adhered on the transfer plate to the substrate or the surface of the transfer plate on which the second brittle material particles under pressure.

19. A manufacturing method of the brittle material structure comprising the steps of:
(iv) adhering the first brittle material particles on a transfer plate, and adhering a mixture of the first brittle material particles and the second brittle material particles onto the first brittle material particles on the transfer plate, and adhering the second brittle material particles onto the mixture, the transfer plate being a metal plate with a high enough elasticity modulus to prevent the brittle material layer from remaining on the metal plate in step (v);
(v) providing the substrate on a surface of the transfer plate on which the second brittle material particles are adhered, and transferring the brittle material layer adhered to the transfer plate onto the substrate by pressurizing the first brittle material particles and the second brittle material particles at a pressure lower than a pressure at which the first brittle material particles and the second brittle material particles are crushed, the substrate being composed of a metal or carbon with a low enough modulus of elasticity to allow the brittle material layer to adhere to the substrate during pressure transfer; and
(vi) adhering the first brittle material particles and the second brittle material particles to the transfer plate using the same process as in the step (iv), and transferring the brittle material layer adhered to the transfer plate onto the brittle material layer on substrate by placing the brittle material layer of the transfer plate on the surface of the transfer plate on which the second brittle material particles are adhered, and applying pressure to the brittle material layer on the transfer plate,
wherein a structure having a desired thickness and formed by cohering the first brittle material particles and the second brittle material particles on the substrate is formed by repeating the step (vi).

20. The method as claimed in claim 19, wherein in the steps (v) and (vi), applying vibration in a lateral direction of the transfer plate to transfer the brittle material layer adhered on the transfer plate to the substrate under pressure.
